(19) United States
(12) Patent Application Publication
(10) Pub. No.: US 2021/0146974 A1
(43) Pub. Date: May 20, 2021

(54) Localization using Millimeter Wave Beam Attributes for Railway Applications

(71) Applicant: Mitsubishi Electric Research Laboratories, Inc., Cambridge, MA (US)

(72) Inventors: Pu Wang, Cambridge, MA (US); Milutin Pajovic, Cambridge, MA (US); Toahiaki Koike-Akino, Cambridge, MA (US); Philip Orlik, Cambridge, MA (US)

(73) Assignee: Mitsubishi Electric Research Laboratories, Inc., Cambridge, MA (US)

(21) Appl. No.: 16/708,434

(22) Filed: Dec. 10, 2019

Related U.S. Application Data
(63) Continuation-in-part of application No. 16/689,431, filed on Nov. 20, 2019.

(51) Int. Cl. B61L 15/00; H04L 29/06

(52) U.S. Cl. CPC B61L 15/0027; H04L 63/0876

(57) ABSTRACT

A system for railway applications using beamforming transmission in a millimeter wave spectrum between antennas of a Communications Based Train Control (CBTC) system and devices in an environment. Performing a beam training with a target device of the devices located in the environment to measure beam signal values and environmental responses for different beams transmitted over the different beam angles using control circuitry connected with the antennas. Control circuitry selects, in response to the beam training, at least one dominant angle for a beamforming communication with the target device. Access stored fingerprinting data that includes values indicative of link attributes associated with beam signal measurements with states of devices and states of environments. Estimating from the mapping stored fingerprinting data, a state of the target device and/or a state of the environment, corresponding to environmental responses for different beams estimated during the beam training.

### FIELD

The present disclosure relates generally to communications systems, and more particularly to millimeter wave fingerprinting-based indoor and outdoor localization with beam signal measurements for assisting with railway Applications including communication of railway operation data and railway control communication.

### BACKGROUND

Conventional train station and subway station environments as well as outside the conventional train station and subway station are very dangerous environments for railroad workers due to not knowing the time or movements of the trains or subway cars, while the railroad workers are working near moving trains or subways. Many railroad workers are seriously hurt or killed because there is little or no warning to alert the railroad worker of an oncoming train or subway, due to train/subway continuing updating track switching, as well as the inability of seeing railroad workers, along with the trains/subways inability to stop quickly. The movements of the cars on the rail tracks can be controlled by several different methods.

For example, train station or subway station environments and areas outside of the stations, sort passenger railroad cars or subway cars onto different railroad tracks or track sections depending on each car's point of destination upon entering a station environment or leaving a station environment. The trains or subway cars require switching, which is transferring of a car from one track to another track, in order for attaching multiple cars together that are all traveling to a same destination. In particular, cars from different tracks need to switch tracks to connect to a specific train or subway that is heading to their specific intended destination. The switching of the train cars or subway cars can be done by remote control systems that allow operators, i.e. switchmen to control trains (i.e. trains with control circuitry allowing remote control access), to be controlled by an on-board train Control Unit (OBTCU) using a portable Switchman Control Unit (SCU) that the switchman/operator carries while located near the railroad track, i.e. not on board of the train, to control the train or subway car.

The switchmen understand how to switch the train cars from track to track according to switching sequences provided in a switch list. The switch list is created by management based on inbound trains arriving in the train station environment or an area outside of the train/subway station, such that each arriving car needs to be switched to their respective destination, by being attached to the outbound trains going to their destination. Wherein the switch list assists the switchman to determine a sequence of switching car positions and car movements to move cars onto appropriate tracks to accomplish an assembly of outgoing trains that ensure that each car is attached to the correct outgoing train destination. However, the switch lists are not typically organized to address the multitude of switching car positions and car movements for each car to be attached to the correct outgoing train destination. Also, the switching lists may be provided for the optimal switching of the cars, which in effect results in inefficient car movements by the switchman among these locations to control the switching of the cars. Never-the-less, a major problem for the railroad workers working their shift, is that these railroad workers do not have the updated switching lists and/or not informed of the time and movements of the cars, while working. If the railroad workers are not informed of the time and movement of the car movements, then they are at risk of being harmed or killed, which presents an unsafe work place for the railroad workers.

In particular, the daily operation of trains requires a significant amount of planning an organizing, along with creating multiple switching lists during each shift that a railroad worker works. Typically, upon arriving to begin the worker's shift, the worker prepares to operate trains for the shift, in part, obtaining the switching list(s). However, by the time the worker arrives at his location in the station environment to begin switching cars per the switching list, a new updated switching list(s) is usually generated, by the end of the worker's shift, there many updated switching lists, each updated list cancels the previous list. Also, these switching lists require a railroad worker for each shift to fill in information, and sign each switching list. In addition to the switching lists, other documents, such as inspection reports, maintenance lists for each car must be review, completed and submitted to a central office for review so as to create a record of work completed for that work shift.

Therefore, there is a need for indoor and outdoor localization systems and methods that can utilize infrastructure-free indoor and outdoor localization to construct a feature space for a location-dependent fingerprinting database, from low cost and implementation perspectives that can assist with improving the safety of railway workers either working within a railway train/subway station or in areas away from the stations.

### SUMMARY

The present disclosure relates to communications systems, and more particularly to millimeter wave fingerprinting-based indoor and outdoor localization with beam signal measurements for assisting with railway Applications including communication of railway operation data and railway control communication. For example, the present disclosure improves tracking railway operation data by non-limiting example, by determining specific times and locations of train/subway car movements and communicating those times and locations to railway workers and other railway personnel including drivers of the trains/subways.

Some systems and methods of the present disclosure include a communication system utilizing millimeter wave fingerprinting-based indoor and outdoor localization with beam signal measurements for assisting with railway Applications including communication of railway operation data and railway control communication. In particular, using a mobile communication device and a central server computer, wherein the communication system or network is established between the central server computer (i.e. a radio-based system described as Communications Based Train Control (CBTC) system and the mobile device (i.e. intelligent mobile access point, a smart phone device, etc.). to communicate computer readable information between the central server computer and the mobile device.

Some embodiments of the present disclosure, include computer-readable information that can be used for assisting in operating a train or subway, such as assisting drivers of the trains or subways of railway workers locations in relation to the current location of the driver. or is otherwise related to an operation of the train/subway.

Some embodiments of the present disclosure, relate to the computer-readable information that is human interface information, by which it is meant information communicated to a human, in text and/or picture form, which the human reads from the hand-held mobile communication device and uses for some purpose in operating the train independent of the hand-held mobile device, for example, information related to a driver of the train or subway location in relation to a final destination location within a station or terminal. Also, the information communicated to the human, could be to the driver of the train or subway or to railway workers, letting both know of the train or subway exact current location. Thus, railway workers working approximate a train or subway approaching the railway workers, the railway workers can be informed to move away from the tracks, in order to ensure the safety of the workers, among other aspects. Further, other data can be provided to the driver of the train or subway and the railway workers including requested railway data, weather data, etc., or the data that can be used for and/or relates to operation of the train). In particular, the CBTC system is a bi-directional system that allows for sending (transmitting) an receiving data via hand-held mobile communication devices for communication back and forth to the central server, i.e. CBTC system.

In accordance with yet another aspect of the present invention, there is provided a method for managing information. The method comprises transmitting a switching lists and other documents used for railway workers, and for drivers of the train for operating the train from either by the driver or by the central server computer to a hand-held mobile device over a network.

In accordance with still another aspect of the present invention, there is provided a method for managing information. The method comprises compiling a plurality of computer-readable documents used for operating a train to form a train operations kit at a central server computer. In addition, the method comprises transmitting one or more of the plurality of computer-readable documents of the train operations kit from the central server computer to a hand-held mobile device over a network. Further, the method comprises displaying the one or more computer-readable documents on a display of the hand-held mobile device.

For example, using mmWave fingerprinting-based indoor and outdoor localization with mmWave beam attributes can include, but not limited to, (1) beam signal-to-noise ratio (SNR) measurements or (2) received signal strength indicator (RSSI) measurements along with beam indices the transceivers on both ends use to establish mmWave link. In industrial standards (e.g., IEEE 802.11ad), such mmWave beam attributes are required to be measured at access points (APs) and clients (e.g., cell phones or laptops) in order to establish reliable mmWave communication links.

The mmWaves exhibit unique propagation characteristics, such as having smaller wavelengths and an antenna size that is much smaller, wherein more antennas may be packed in a relatively small area, thereby allowing for the implementation of a high-gain antenna in small form factor. Further, the mmWaves can be used for localizing objects such as train/subway cars and drivers of the train/subway cars, in an enclosed indoor area or in an outdoor area. The objects can be associated with a mobile communication device that transmits and/or receives signals to/from some other device(s), or an entity without such a capability. The localizing refers to estimating the coordinates of the object associated with a communication device, in some pre-defined reference frame, such as a train/subway car location and a driver of the train/subway car location. Localization, alternatively, is a proximity detection problem, that aims to localize an object at a sub-area level, within a larger indoor area and an outdoor area. Thus, using mmWaves associated with identifying locations of train/subway cars or drivers of the train/subway cars can solve the conventional safety problems associated with railroad workers, by accurately determining locations and movements of train/subway cars, as well as distances of the train/subway cars to each railroad worker associated with a mobile communication device.

In particular, some embodiments use intermediate channel measurements, e.g., spatial beam SNRs that are inherently available in the IEEE 802.11ad standard, to construct a feature space for a location-dependent fingerprinting database. Through experimentation, at least one realization realized is that the use of spatial beam SNRs, conveniently available during a beam training phase in 5G and 802.11ad standards, can be used as location fingerprints with zero overhead. More specifically, during a so-called beam training phase, a pre-determined set of varying spatial beam patterns can be used to probe the environment. Such that, for each probing beam pattern, a spatial beam SNR is recorded and the beam pattern yielding a strongest beam SNR can be selected for subsequent data transmission. Wherein, based on the availability of open source software, the open source software framework can be used to extract such beam SNR measurements (e.g., at 60-GHz WiFi band), to build an experimental platform consisting of multiple APs, that can be used to collect comprehensive indoor measurements in an environment. Note that these measurements, i.e. real-world measurements, can account for hardware constraints such as quantization of beam SNR values (e.g., beam SNRs that are acquired at a resolution of 0.25 dB) and non-ideal system factors such as non-ideal antenna beam patterns and irregular antenna housing. Thus, with these real-world beam SNR measurements at several locations-of-interest within the environment, a fingerprinting dataset can be constructed in an offline training phase. For an online localization phase, both position classification and coordinate estimation can be considered using statistical estimation and machine learning approaches.

In regard to the fingerprinting dataset, at least one embodiment can construct the fingerprinting dataset using the SNR measurements, as noted above. Wherein data is stored in a memory including values indicative of the SNR measurements of a set of beams emitted at different beam angles by the phased antenna array and measured at a set of locations and orientations, that provide for a mapping between different combinations of SNR values of the set of beams and the set of locations and orientations. Such that a location and orientation from the set of locations is mapped to a unique combination of the SNR values of the set of beams.

However, discovered from experimentation, is that other measurements can be used to construct the fingerprinting dataset in the offline training phase, aside from just using the SNR measurements. For examples, the other measurements may be one or a combination of, beam RSSI measurements, beam channel state information (CSI) measurements, SNR measurements, RS SI measurements, CSI measurements, beam patterns, beam sequencing, and packet information (timing, sequencing). Wherein, at least one embodiment can construct the fingerprinting dataset using these other measurements, i.e. one or a combination of, as values indicative of measurements of a set of beams emitted at different beam angles by the phased antenna array and measured at a set of locations and orientations, that provide for a mapping between different combinations of values of the set of beams and the set of locations and orientations. Wherein a location and orientation from the set of locations and orientations can be mapped to a unique combination of the SNR values of the set of beams.

Also, discovered from experimentation is that the stored data can also be used as values indicative of “beam attributes”. The “beam attributes” may be associated with the beam signal measurements with states of devices and/or states of environments.

The “states of the devices” can include types of behavior associated with each device (wherein a user can be associated with each device), locations and poses of each device in each environment. For example, each device can be associated with a user, such that the user is one of a robot, a human, a computer, a computer like device or an electronic device adaptable to a human. Wherein some types of behavior associated with each device can include, by-non-limiting example: (1) locations and poses of a specific user holding a device in the environment; (2) a device may be attached, embedded or somehow part of a human, i.e. maybe an implant, a component of a prosthetic, etc., such that locations and poses of the human with the device can be obtained; (3) a device could be a computer device that is static or dynamic within an environment, i.e. commercial or business environment, including manufacturing, hospital, assembly line, transportation system, product transportation, i.e. the computer device could be part of a tracking/monitoring network, etc.; (4) a device could be adaptable to a human such as part of a wrist device, or some other types of devices or clothing worn by a human; and (5) a device can be a mobile communication device of a user attempting to access a vehicle via keyless entry.

The “states of environments” can include locations of physical objects and types of behavior of ambient users in each environment. The locations of physical objects in each environment, can include objects found in a particular type of environment. By-non-limiting example: (1) in an office environment, the objects may include furniture, pillars, doors, machinery, robots, etc.; and (2) in an industrial or manufacturing environment, the objects can include any component either static or dynamic within the environment. As noted above, a user may be one of a robot, a human, a computer, a computer like device or an electronic device adaptable to a human. Wherein, by-non-limiting example, the types of behavior of ambient users can include: (1) a robot, i.e. a static robot having moving components or a dynamic robot, movements within the environment; (2) a human or a group of humans movement within the environment; (3) a computer maybe associated with a dynamic device that moves within the environment; (4) an electronic device adaptable to static devices having moving components, mobile devices, humans, etc., that are located in an the environment, i.e. commercial, business or residential.

According to some embodiments of the present disclosure, the fingerprinting dataset in the offline training phase is stored in a memory, and can be used, by non-limiting example, with control circuitry connected to the phased antenna array and the memory. Wherein, the control circuitry performs a beam training with a target device located in the environment to measure beam signal values and environmental responses for different beams transmitted over the different beam angles. In response to the beam training, selects at least one dominant angle for a beamforming communication with the target device. Estimates from the stored fingerprinting data in the memory, a state of a target device, a state of the environment, or a combination of both states corresponding to the environmental responses for different beams estimated during the beam training. Then, transmits the estimated states of the target device and environment using the phased antenna array via a beamforming transmission over the at least one dominant angle to communicate the state of the target device, the state of the environment, or both states.

### Experimentation

However, in order to better understand how and why some of the above embodiments were discovered, one needs to review the experimentation that led to some of the discoveries noted above. For example, at the start of experimentation some fingerprinting-based methods tested appeared to provide an efficient solution for online localization with low computational complexity. Though, what was later discovered is that these fingerprinting-based methods all required an enormous amount of time and resources to construct an offline database with chosen fingerprinting features at locations-of-interest within an environment to enable fast online localization. Upon further review of these tested WiFi-based fingerprinting systems, RSSI measurements were used as a feature to construct an offline training database, mostly due to the fact that this is the most easily accessible measurement from IEEE 802.11ac devices at sub-6 GHz, and also because of the low hardware requirements on data collection. Further, some machine learning methods such as the k-nearest neighbor (kNN) were applied to the RSSI-based fingerprinting data and showed some improved localization accuracy based on the particular experimentation. Some aspects learned from this experimentation revealed common issues using the RSSI, such as: 1) instability of using RSSI measurements at a given location; and 2) the coarse-grained channel information provided by the RSSI measurements. Also realized were further challenges that needed to be overcome, for example, the RSS are a coarse value which only simply measures the received power for a whole channel. In other words, the RSS fluctuates over time in typical indoor environments with rich multipath effects and are not unique for a specific location.

Another experimentation tested included the use of full channel state information (CSI) for fingerprinting-based localization at 2.4-GHz and 5-GHz frequency bands. An initial impression was that it would be easier to obtain such CSI measurements from open-source WiFi network interface cards (NICs), such as Intel WiFi Link 5300 NIC. Wherein, these NICs provided subcarrier channel frequency responses (CFR) in an orthogonal frequency-division multiplexing (OFDM) system and captured a multipath effect via wideband channel responses. When compared with RSSI measurements experimentation, these CSI measurements appeared to be more stable and provide location-dependent features. One experimentation included using a Fine-grained Indoor Fingerprinting System (FIFS), the FIFS system leveraged a weighted average of CSI amplitudes over three antennas, that included different amplitudes and phases at multiple propagation paths, known as the frequency diversity, to uniquely manifest a location. Further, the multiple antennas appeared to also provide a spatial diversity that could be further augmented in fingerprinting.

Still, another experimentation tested included a deep learning based indoor fingerprinting system that used CSI, i.e. DeepFi. This experimentation used a DeepFi system architecture that included an off-line training phase and an on-line localization phase. In the off-line training phase, deep learning was utilized to train all the weights of a deep network as fingerprints. Where, a greedy learning algorithm was used to train the weights layer-by-layer to reduce complexity. In the on-line localization phase, a probabilistic method based on a radial basis function was used to obtain an estimated location. In the FIFS experimentation, the CSI amplitude values from three antennas were simply accumulated to produce an average value. In contrast, for the DeepFi experimentation had aimed to utilize their variability to enhance the training and test process in deep learning. For example, 30 subcarriers were treated as 30 nodes and used as input data of visible variability for deep learning. Wherein, with the three antennas, there were 90 nodes that could be used as input data for deep learning. Which seemed that the experimented DeepFi approach appeared to exploit 90 CSI amplitudes from all the subcarriers at all the three antennas with a deep auto-encoder network. However, upon reflection of developing the embodiments of the present disclosure was that the CSI measurements were available in 2.4/5 GHz communication systems, and online in mmWave systems that are envisioned to dominate the future WiFi market.

However, practical implementation of the CSI-based fingerprinting method later turned out to be very challenging when using with current mmWave technology and communication standards. Namely, only a limited number of radio frequency (RF) chains were implemented into mmWave transceiver due to hardware-related constraints. Which this precluded them from processing signals from all antenna elements in discrete-time domain and obtaining mmWave channel angular spectrum. Instead, what was realized and required by industrial standards is that the mmWave transceiver implements a finite number of possible beam patterns such that two mmWave devices can establish a communication link based on probing different combinations of beams and choosing the best link based on the received signal quality. In addition, even those limited channel measurements were not (easily) accessible from commercial mmWave chipsets, which posed additional challenges to mmWave-aided localization.

Experimentation showed that in regard to higher frequency bands beyond 5-GHz frequency band, e.g., 28-GHz band for 5G wireless communications and 60-GHz for 802.11ad WiFi, obtaining real-world fingerprinting measurements, such as full CSI, proved significantly more challenging and required dedicated prototyping device platforms. Namely, to acquire CSI in mmWave receiver, a separate radio frequency (RF) chain was needed in each antenna element. Also, due to the large bandwidth of mmWave communication signals, an analog-to-digital converter (ADC) in each RF chain needs to have a relatively high sampling rate and, in turn, consume large amounts of power. Overall, after several types of experimentation, the resulting baseline consensus was that such a system would be too expensive and very impractical for commercial use with current mmWave technology.

Discoveries & Realizations

What was discovered is that one of the unique features of these mmWave applications was to employ high-resolution beam patterns, via either analog beamforming, or hybrid beamforming, which could be used to compensate for higher path loss. More specifically, during an experimental beam training phase, a pre-determined set of varying spatial beam patterns were used to probe the environment. Such that, for each probing beam pattern, a spatial beam SNR was recorded, the beam pattern yielding the strongest beam SNR was selected for subsequent data transmission. For a given probing beam pattern, spatial beam SNR was a RSSI-like coarse-grained channel measurement. However, this turned out to be a benefit due to the use of multiple varying beam patterns, wherein a set of spatial beams SNRs can embed more spatial channel responses than the traditional RSSI measurement. Further still, another realized benefit is that the spatial beam SNRs were inherently available in the 5G and IEEE 802.11ad standard, which enabled a zero overhead for the overall hardware and software infrastructure.

Thus, based on different experimentation, spatial beam SNRs were decided to be used, for many reasons, one reason for being conveniently available during a beam training phase in 5G and 802.11ad standards, and can be used as location fingerprints at a zero overhead. Another reason is spatial beam SNRs can be based on open source software that is easily available, and the open source software framework could be used to extract 60-GHz beam SNR measurements. For example, an experimental platform was built consisting of multiple APs, in order to collect comprehensive indoor measurements in a test environment, i.e. the test environment was an office environment tested during regular office hours. Note that these real-world measurements accounted for hardware constraints such as quantization of the beam SNR values, e.g., beam SNRs were delivered with a resolution of 0.25 dB, and non-ideal system factors such as non-ideal antenna beam patterns and antenna housing. With these real-world beam SNR measurements at several locations-of-interest within the test environment, a fingerprinting dataset in the offline training phase was constructed. For the online localization phase, both position classification and coordinate estimation were undertaken using a weighted nearest neighboring and Gaussian process regression approaches, as noted above.

In an alternative embodiment, the locations of interest are fingerprinted using RSSI measurements of the established mmWave link between two devices and indices of the built-in beam patterns the two devices use for establish such a link. The reason is that the RSSI and beam indices are more easily available from commercial devices than the SNR values of the probed beams. Also, while it has been experimentally shown that fingerprint-based localization using RSSI measurements only does not provide satisfactory localization performance, including beam indices reduces the search space of indoor location and, in turn, considerably improves the localization performance.

Some embodiments include a system using beamforming transmission in a mmWave spectrum in an environment. The system includes a phased antenna array that performs beamforming to establish millimeter wave channel links with devices at different locations in the environment. A memory can have stored data that includes fingerprinting data. The fingerprinting data can include values indicative of SNR measurements of a set of beams emitted at different beam angles by the phased antenna array and measured at a set of locations in the environment. Wherein the stored values indicative of SNR measurements of a set of beams emitted at different beam angles by the phased antenna array and measured at a set of locations, that provide for a mapping between different combinations of SNR values of the set of beams and the set of locations. Such that a location from the set of locations is mapped to a unique combination of the SNR values of the set of beams.

Control circuitry communicatively connected with the phased antenna array and the memory, configured to perform a beam training with a target device located in the environment to estimate SNR values for different beams transmitted over the different beam angles. During the beam training, the transmitter and receiver probe a certain number of beams transmitted with different beamforming angles. For example, during the beam training, the transmitter sends training sequence in each beam sequentially and the receiver steers sequentially in all tested beams and measures strength of the signal from each steered beam. The beam training yields a path between the transmitter and receiver over which they establish a communication link.

The control circuitry can select, in response to the beam training, at least one dominant angle for a beamforming communication with the target device. Wherein the selecting is based on the signal strength (such as RSSI or SNR or some other metric) measured for each probed beam such that the beam that delivers the strongest signal is used to closing the link between the two devices.

The control circuitry can estimate from the mapping stored in the memory, a location of the target device corresponding to the SNR values for different beams estimated during the beam training. Wherein the estimating is based on one of machine learning or deep learning methods, aimed to map measured SNR values to the unknown location and orientation of the device.

The control circuitry can also estimate from the mapping stored in the memory, a location of the target device corresponding to the RSSI and beam indices values corresponding to the established link during the beam training. Wherein the estimating is based on the disclosed probabilistic method, aimed to map measured RSSI and beam indices to the unknown location and orientation of the device. Wherein the control circuitry transmits the location of the target device using the phased antenna array via a beamforming transmission over the at least one dominant angle to communicate the location of the target device.

According to an embodiment of the present disclosure, a communication system for railway applications using beamforming transmission in a millimeter wave spectrum between a central server computer or a radio-based system such as a Communications Based Train Control (CBTC) system and devices in an environment to establish the communication system, the CBTC system includes phased antenna arrays configured to perform beamforming to establish millimeter wave channel links between the CBTC system and the devices at different locations in the environment. Wherein the devices include a target device and the environment includes a train station area. The communication system including a memory connected to the phased antenna arrays and stored data. The stored data include values indicative of signal to noise ratio (SNR) measurements of a set of beams emitted at different beam angles by the phased antenna arrays and measured at a set of locations, that provide for a mapping between different combinations of SNR values of the set of beams and the set of locations. Such that a location from the set of locations is mapped to a unique combination of the SNR values of the set of beams. Control circuitry communicatively connected with the phased antenna arrays and the memory, configured to perform a beam training with the target device associated with at least one railway application located in the environment to estimate SNR values for different beams transmitted over the different beam angles. Select, in response to the beam training, at least one dominant angle for a beamforming communication with the target device. Estimate from the mapping stored in the memory, a location of the target device corresponding to the SNR values for different beams estimated during the beam training. Transmit the estimated location of the target device associated with at least one railway application using the phased antenna arrays via a beamforming transmission over the at least one dominant angle.

According to another embodiment of the present disclosure, an electronic communication system for railway applications using beamforming transmission in a millimeter wave spectrum between a central server computer or a radio-based system such as a Communications Based Train Control (CBTC) system and devices in an environment to establish the electronic communication system, the CBTC system includes antennas configured to transmit and receive millimeter wave signals between the CBTC system and the devices at different locations in the environment. Wherein the devices include a target device and the environment includes a train station area. The electronic communication system including a memory connected to the antennas, and stored data. The stored data include values indicative of signal to noise ratio (SNR) measurements of a set of beams emitted at different beam angles by the antennas and measured at a set of locations, that provide for a mapping between different combinations of SNR values of the set of beams and the set of locations. Such that a location from the set of locations is mapped to a unique combination of the SNR values of the set of beams. Control circuitry connected with the antennas and the memory, is configured to perform a beam training with the target device associated with at least one railway application located in the environment to estimate SNR values for different beams transmitted over the different beam angles. Select, in response to the beam training, at least one dominant angle for a beamforming communication with the target device. Estimate from the mapping stored in the memory, a location of the target device corresponding to the SNR values for different beams estimated during the beam training. Transmit the estimated location of the target device associated with the at least one railway application using the antennas via a beamforming transmission over the at least one dominant angle.

Another embodiment of the present disclosure a method using a communication system for railway applications having beamforming transmission in a millimeter wave spectrum between a central server computer or a radio-based system such as a Communications Based Train Control (CBTC) system and devices in an environment to establish the communication system, the CBTC system includes phased antenna arrays configured to perform beamforming to establish millimeter wave channel links between the CBTC system and the devices at different locations in the environment. Wherein the devices include a target device and the environment includes a train station area. The method including performing a beam training with the target device associated with at least one railway application located in the environment to estimate SNR measurement values for different beams transmitted over the different beam angles using control circuitry connected with the phased antenna arrays. The control circuitry is configured for selecting, in response to the beam training, at least one dominant angle for a beamforming communication with the target device. Accessing a memory connected to the phased antenna arrays, the memory having stored data. The stored data include values indicative of SNR measurements of a set of beams emitted at different beam angles by the phased antenna arrays and measured at a set of locations in the environment. Wherein the stored values provide a mapping between different combinations of SNR values of the set of beams and the set of locations. Such that a location from the set of locations is mapped to a unique combination of the SNR values of the set of beams. Estimating from the mapping stored in the memory, a location of the target device corresponding to the SNR values for different beams estimated during the beam training. Transmitting the estimated location of the target device associated with the at least one railway application using the phased antenna arrays via a beamforming transmission over the at least one dominant angle.

Another embodiment of the present disclosure includes a communication system for railway applications using beamforming transmission in a millimeter wave spectrum between a central server computer or a radio-based system such as a Communications Based Train Control (CBTC) system and devices in an environment to establish the communication system, the CBTC system includes antennas configured to perform beamforming to establish millimeter wave channel links between the CBTC system and the devices at different locations in the environment. Wherein the devices include a target device and the environment includes a train station area. The communication system including a memory connected to the antennas, and stored fingerprinting data. The stored fingerprinting data include values indicative of link attributes associated with beam signal measurements with states of devices and states of environments. The states of the devices include types of user behavior associated with each device, locations and poses of each device in each environment. The states of the environments include locations of physical objects and types of behavior of ambient users in each environment. Control circuitry communicatively connected with the antennas and the memory, is configured to perform a beam training with the target device associated with at least one railway application located in the environment to measure beam signal values and environmental responses for different beams transmitted over the different beam angles. Select, in response to the beam training, at least one dominant angle for a beamforming communication with the target device. Estimate from the stored fingerprinting data in the memory, a state of the target device, a state of the environment, or a combination of both states corresponding to the environmental responses for different beams estimated during the beam training Transmit the estimated states of the target device associated with the at least one railway application and environment using the antennas via a beamforming transmission over the at least one dominant angle to communicate the state of the target device, the state of the environment, or both states.

Another embodiment of the present disclosure a method using a communication system for railway applications having beamforming transmission in a millimeter wave spectrum between a central server computer or a radio-based system such as a Communications Based Train Control (CBTC) system and devices in an environment to establish the communication system, the CBTC system includes antennas configured to perform beamforming to establish millimeter wave channel links between the CBTC system and the devices at different locations in the environment. Wherein the devices include a target device and the environment includes a train station area. The method including performing a beam training with the target device associated with at least one railway application located in the environment to measure beam signal values and environmental responses for different beams transmitted over the different beam angles using control circuitry connected with the antennas. The control circuitry is configured for selecting, in response to the beam training, at least one dominant angle for a beamforming communication with the target device. Accessing a memory connected to the antennas, the memory having stored fingerprinting data. The stored fingerprinting data include values indicative of link attributes associated with beam signal measurements with states of devices and states of environments. The states of the devices include types of user behavior associated with each device, locations and poses of each device in each environment. Wherein the states of the environments include locations of physical objects and types of behavior of ambient users in each environment. Estimating from the mapping stored fingerprinting data in the memory, a state of the target device, a state of the environment, or a combination of both states corresponding to the environmental responses for different beams estimated during the beam training. Transmitting the estimated states of the target device associated with the at least one railway application and environment using the antennas via a beamforming transmission over the at least one dominant angle to communicate the state of the target device, the state of the environment, or both states.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A is a block diagram illustrating a method, according to an embodiment of the present disclosure;

FIG. 1B is a schematic illustrating some components used for implementing the method of FIG. 1A, according to some embodiments of the present disclosure;

FIG. 1C is a schematic illustrating wireless communication between two devices that can communicate with channel links, according to some embodiments of the present disclosure;

FIG. 2A and FIG. 2B illustrate shows magnitudes of two transmit beams, labeled with beam indices and experimentally measured in an anechoic chamber, according to some embodiments of the present disclosure;

FIG. 3A is a schematic illustrating a millimeter wave fingerprinting-based indoor and outdoor localization with beam signal measurements for assisting with railway Applications including communication of railway operation data and railway control communication, according to some embodiments of the present disclosure;

FIG. 3B is a schematic illustrating another millimeter wave fingerprinting-based indoor and outdoor localization with beam signal measurements for assisting with railway Applications including communication of railway operation data and railway control communication, that further includes cameras/video cameras, according to some embodiments of the present disclosure.

FIG. 3C and FIG. 3D are schematics illustrating railway communications systems utilizing millimeter wave fingerprinting-based indoor and outdoor localization with beam signal measurements for assisting with railway Applications including communication of railway operation data and railway control communication, according to some embodiments of the present disclosure;

FIG. 3E is a schematic illustrating another conventional high-density Wi-Fi topology for a rail station that can be used with the systems and methods of the present disclosure, according some embodiments of the present disclosure;

FIG. 4 is a schematic illustrating another millimeter wave fingerprinting-based indoor and outdoor localization with beam signal measurements for assisting with railway Applications including communication of railway operation data and railway control communication, according to some embodiments of the present disclosure;

FIG. 5A is a schematic of using all collected beam attributes at all fingerprinting locations, orientations, heights, poses, etc. to train probabilistic method, machine learning, and deep learning modules, according to some embodiments of the present disclosure;

FIG. 5B is a schematic of applying the trained probabilistic method, machine learning, and deep learning modules to new collected beam attributes at unknown locations, orientations, heights, poses, etc. for the purpose of localization, according to some embodiments of the present disclosure;

FIG. 6 is a schematic illustrating the probabilistic method when the beam attributes include the RSSI and transmit beam indices, according to some embodiments of the present disclosure;

FIG. 7 is a block diagram illustrating machine learning approaches including kNN, LDA/QDA, SVM, GP, etc. to classify new fingerprinting measurements into one of training locations, orientations, poses, etc., according to some embodiments of the present disclosure;

FIG. 8 is a schematic illustrating a DNN architecture for indoor localizations, according to some embodiments of the present disclosure;

FIG. 9 is a block diagram illustrating another system, according to an embodiment of the present disclosure;

FIG. 10A is a schematic illustrating a computing apparatus that can be used to implement some techniques of the methods and systems, according to embodiments of the present disclosure; and

FIG. 10B is a schematic illustrating a mobile computing apparatus that can be used to implement some techniques of the methods and systems, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure relates generally to communications systems, and more particularly to millimeter wave fingerprinting-based indoor localization with beam SNR measurements. In particular, the present disclosure discloses a low-cost fingerprint-based localization method, where in addition to the RSS measurements, also discloses fingerprint beam indices that two mmWave devices select from a finite set of feasible beams during their beam alignment procedure.

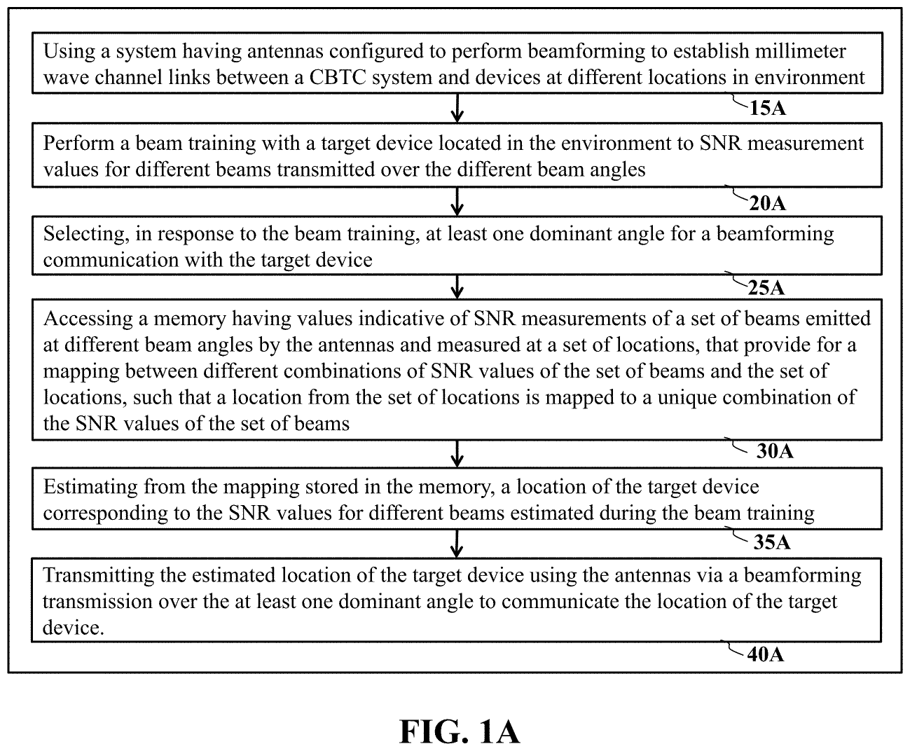

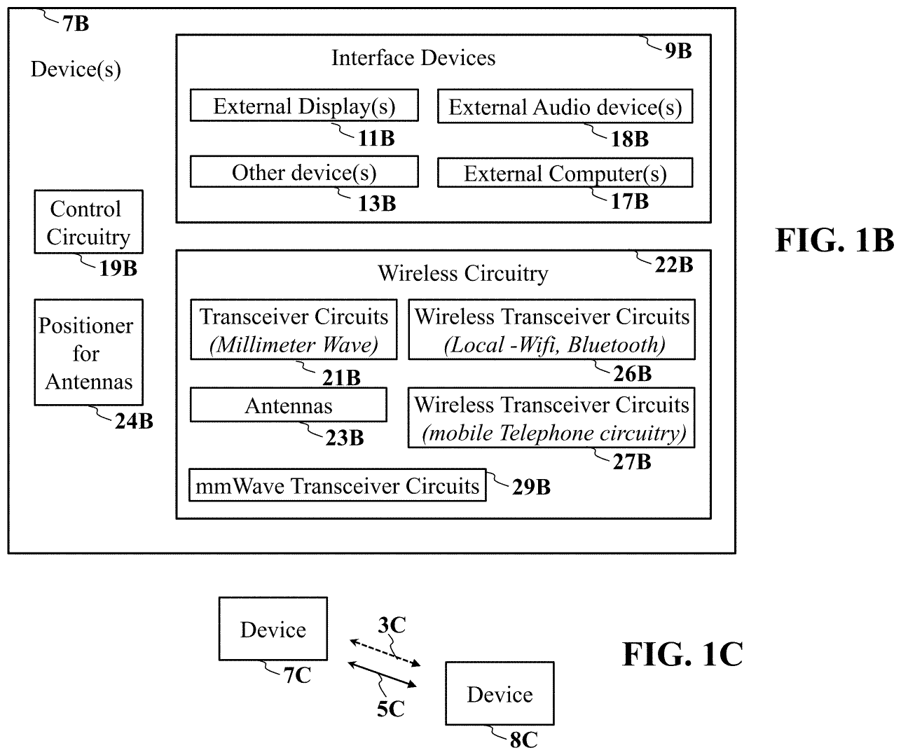

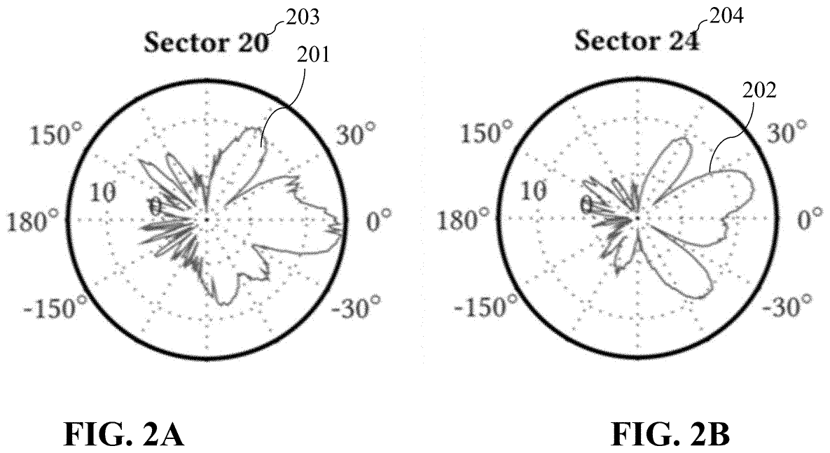

FIG. 1A is a block diagram of a method, according to an embodiment of the present disclosure.

Step 15A of FIG. 1A includes using a communication system having beamforming transmission in a millimeter wave spectrum in an environment, that includes a phased antenna array configured to perform beamforming to establish millimeter wave channel links with devices at different locations in the environment.

Step 20A of FIG. 1A includes performing a beam training with a target device located in an environment to estimate signal to noise ratio (SNR) measurement values for different beams transmitted over the different beam angles using control circuitry connected with the antennas.

Step 25A of FIG. 1A includes the control circuitry is configured for selecting, in response to the beam training, at least one dominant angle for a beamforming communication with the target device.

Step 30A of FIG. 1A includes accessing a memory connected to the phased antenna array, the memory having stored data that includes values indicative of SNR measurements of a set of beams emitted at different beam angles by the phased antenna array and measured at a set of locations in the environment, wherein the stored values provide a mapping between different combinations of SNR values of the set of beams and the set of locations, such that a location from the set of locations is mapped to a unique combination of the SNR values of the set of beams.

Step 35A of FIG. 1A includes estimating from the mapping stored in the memory, a location of the target device corresponding to the SNR values for different beams estimated during the beam training.

Step 40A of FIG. 1A includes transmitting the location of the target device using the phased antenna array via a beamforming transmission over the at least one dominant angle to communicate the location of the target device.

FIG. 1B is a schematic illustrating the device having some components with wireless communication circuitry used for implementing the methods of FIG. 1A, according to some embodiments of the present disclosure. The device 7B can include control circuitry 19B, that can include storage, i.e. flash memory, nonvolatile/volatile memory, hard disk drive storage, programmable-read-only memory, etc. The control circuitry 19B can be configure to utilize the processing circuitry to control the operation of device 7B, such as microcontrollers/processors, signal processors, etc.

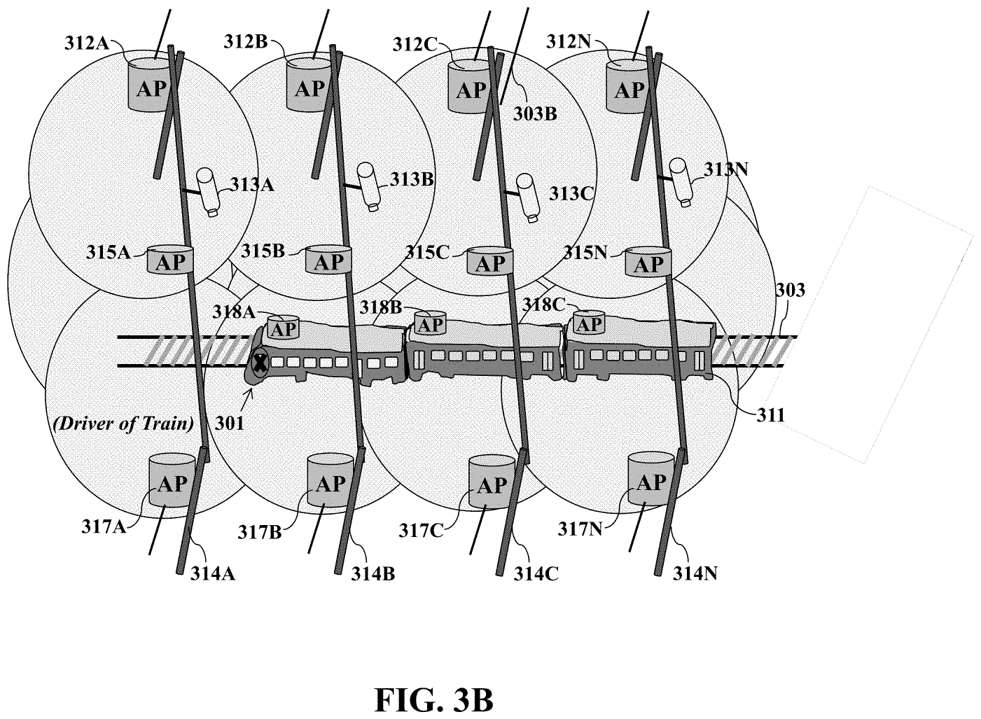

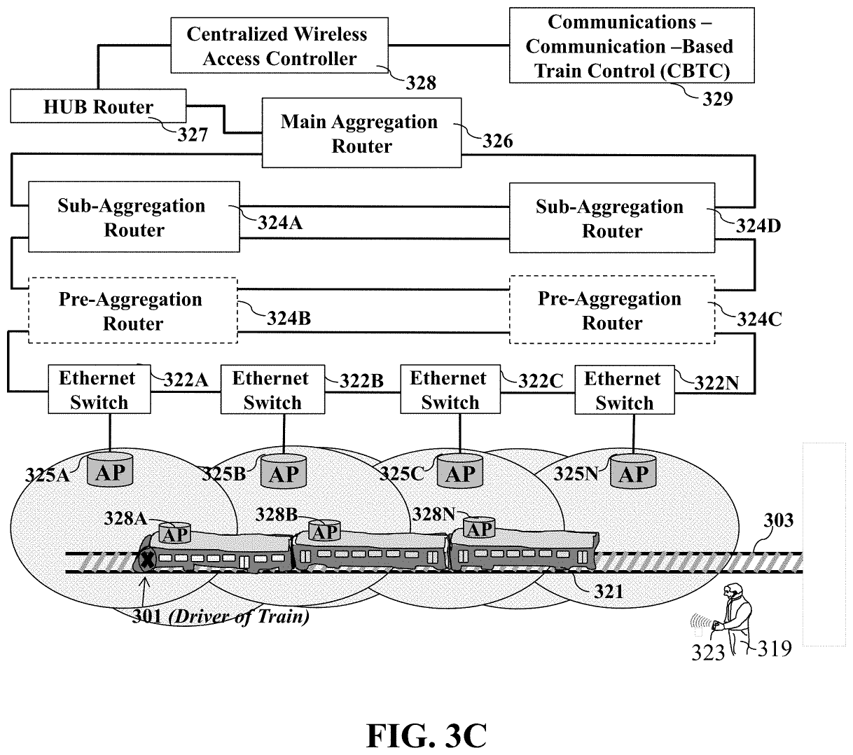

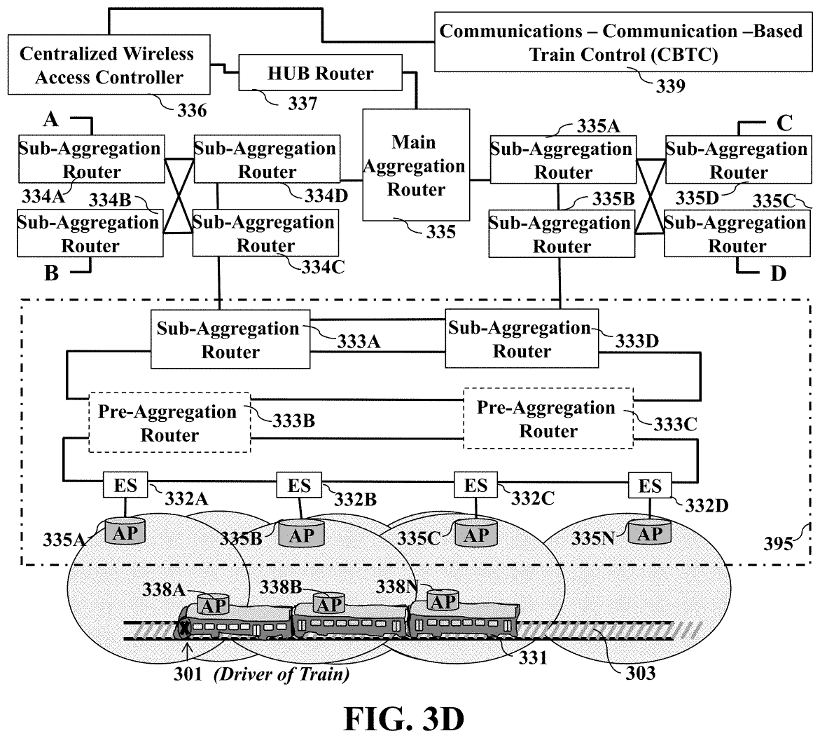

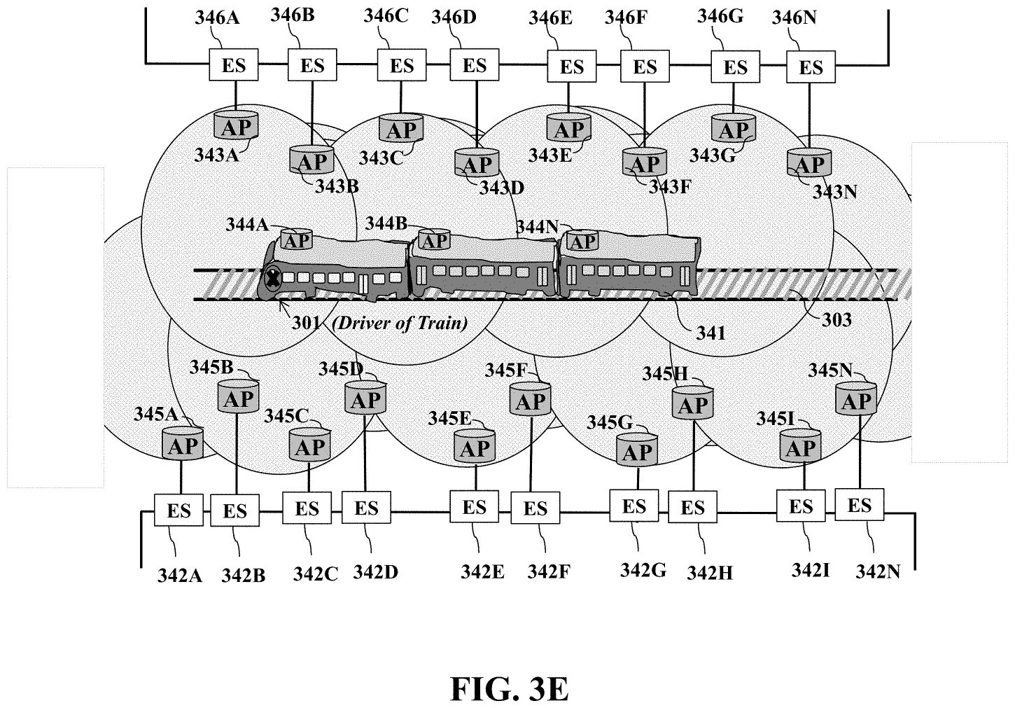

Control circuitry 19B can be used to run software on the device 7B, where the control circuitry 19B can be configure to support communications with other equipment, such as implementing communication protocols, i.e. wireless local area network protocols (IEEE 802.11, IEEE 802.11ad, wireless telephone, etc. The device 7B can include interface devices 9B having circuitry to communicate data to be supplied to the device and/or allow data to be provided from the device 7B to external or other devices, i.e. external displays 11B, external audio devices 18B, other devices 13B, external computers 17B, or other like devices such as the device 7B, for example, 7C of FIG. 1C. Other components are contemplated that can be incorporated into the device 7B or sub-components of the device 7B, such as, one or a combination of Remote Access Device that can include application memory, controller, satellite positioning receiver, wireless communication circuitry, accelerometer, authentication device, and antennas. Further, the device can be in communication with an electronic lock system associated with a vehicle, the lock system can include deadbolt, application memory, controller, wireless communication circuitry, accelerometer, proximity detector, interior and exterior antennas, and authentication. The device 7B can also include a router plugin unit that can include a controller, radio, processor, computer, etc., that can communicate with the internet and cell network. Contemplated is that the device 7B can be fixed (see FIG. 3A, 305A, 305B, 305C), or a mobile device (see FIG. 3A, 309).

Optionally, the device 7B can include a non-transitory computer readable storage medium 9B embodied thereon a program executable by a processor for performing a method, i.e. a method that can include executing control policies, and the like. Also, optionally the device 7B can include one or more processors 11B, depending upon the intended specific application. Further, optionally one or more power supply 10B can be provided either integrally or externally, depending upon the specific application.

The device 7B can include wireless communications circuitry 22B for communicating wirelessly with other equipment. The wireless communications circuitry 22B may include transceiver circuitry 21B formed from one or more integrated circuits, power amplifier circuitry, low-noise input amplifiers (not shown), passive RF components (not shown) and one or more antennas 23B. Also, the wireless communications circuitry 22B can include wireless transceiver circuits 26B (local-WiFi, Bluetooth, wireless local area network, configured for 2.4 GHz, 5 GHz bands for IEEE 802.11, etc.), and wireless transceiver circuits 27B including mobile telephone circuitry. Depending upon the user intended applications one or all of the above components can be included. Further, optionally one or more power supply 28B can be provided either integrally or externally, depending upon the specific application. Also, optionally can be a control computer 21B if the specific application needs one.

Still referring to FIG. 1B, the wireless communications circuitry 22B may include mmWave transceiver circuitry 29B that supports communications at frequencies of 7 GHz to 300 GHz or other mmWave frequencies. For example, the mmWave transceiver circuitry 29B may support IEEE 802.11ad communications at 28 GHz or 60 GHz, and may be configure from an integrated circuit(s).

Antennas 23B can include the wireless communications circuitry 22B that can configure for use with multiple different types of antennas (see also FIG. 3B and FIG. 3C). For example, the different types of antennas can be used for different bands and combinations of bands. One type of antenna may be used in forming a local wireless link antenna and another type of antenna may be used in forming a remote wireless link antenna. Antennas 23B can include phased antenna arrays for handling millimeter wave communications. Also, the antenna signals can be routed via transmission line paths within device 7B, wherein the transmission line paths may be used to couple antenna structures 23B to transceiver circuitry. The device 7B can include multiple antennas 23B, such that the antennas may be used together or one of the antennas may be switched into use while other antenna(s) are switched out of use. For example, the control circuitry 19B can be used to select an ideal antenna to use in device 7B in real time and/or to select an ideal setting for adjustable wireless circuitry associated with one or more of antenna 23B. Antenna adjustments may be made to tune antennas to perform in desired frequency ranges, to perform beam steering with a phased antenna array, and to otherwise optimize antenna performance. Sensors may be incorporated into antennas 23B to gather sensor data in real time that is used in adjusting antennas 23B.

Still referring to FIG. 1B, the antennas 23B can include phased antenna arrays to implement beam steering functions, wherein the antennas used in handling mmWave signals for frequency mmWave transceiver circuits 29B may be implemented as phased antenna arrays. The radiating elements in a phased antenna array 23B for supporting millimeter wave communications may be patch antennas, dipole antennas, or other suitable antenna elements. The mmWave transceiver circuitry 29B can be integrated with the phased antenna arrays 23B to form integrated phased antenna array and transceiver circuit modules or packages.

Objects in the environment can block wireless signals such as mmWave signals, such that mmWave communications usually require a line of sight between antennas 23B and the antennas on an external device. Accordingly, the device 7B can have multiple phased antenna arrays, each of which can be placed in a different location within or on device 7B. With this type of arrangement, an unblocked phased antenna array may be switched into use and, once switched into use, the phased antenna array may use beam steering to optimize wireless performance. Similarly, if a phased antenna array does not face or have a line of sight to an external device, another phased antenna array that has line of sight to the external device may be switched into use and that phased antenna array may use beam steering to optimize wireless performance. Configurations in which antennas 23B from one or more different locations in device 7B are operated together may also be used (e.g., to form a phased antenna array, etc.).

Still referring to FIG. 1B, to further improve mmWave communications, the device 7B may include positioners 24B that can include mechanically moveable (adjustable) structures that are controlled to mechanically adjust the position of antennas 23B with respect to device 7B and/or the external device (e.g., to maintain line of sight with the external device).

Control circuitry 19B can provide control signals to the positioners 24B to mechanically adjust the position or orientation of the antennas 23B by an actuating motion of the positioners 24B via electrical control signals that actuate a change in an orientation or position of antennas 23B. For example, the positioners 24B can adjust the orientation or position of one of antenna 23B, or multiple antennas at different times.

FIG. 1C is a schematic illustrating wireless communication between two devices that can communicate with channel links, according to some embodiments of the present disclosure. Device 7C and device 8C can be the same or similar to the device 7B of FIG. 1B, depending upon the specific intended application.

For example, device 7C and device 8C can include antennas, each having a phase antenna array, such that both phase antenna arrays are designed for link establishment for mmWave communications and networks, for fingerprinting-based localization. Specific applications can include indoor localization of static and moving objects including people, robots, vehicles and drones, outdoor localization, tracking of static and moving objects. Both devices 7C, 8C are designed for use of commercially available beam SNR measurements, which is different from other measurement modalities used by conventional fingerprinting-based localization approaches. For example, some existing mmWave fingerprinting-based localization approaches use either CSI) which requires expensive prototyping mmWave platforms or RSSI that are coarse measurements with little information on spatial propagation paths.

The mmWave communications can include signals above 7 GHz, including 28 GHz, 60 GHz or other frequencies between about 7 GHz and 300 GHz. The devices 7C, 8C can include wireless communications circuitry for local wireless area network signals, near-field communications, cellular telephone signals, light-based wireless communications, satellite navigation system signals or other wireless communications. For example, the devices 7C, 8C can be wireless electronic devices, computers, laptops, or any type of device capable of being associated with communication circuitry that uses beam SNR designed for link establishment for mmWave communications and networks, for fingerprinting-based localization. Other examples can include devices designed for use by humans, either embedded into the human or carried or attached to the human. Further, the devices 7C, 8C can be associated with a fixed communication device for at a fixed location, or a mobile communication device for a vehicle. For example, the devices 7C, 8C can include a wireless AP or a base station such as a wireless router or other device for routing communications between other wireless devices and a larger network such as the internet or a cellular telephone network.

The devices 7C, 8C include wireless circuitry to perform mmWave communications over a wireless mmWave link such as mmWave link 3C, 5C. The mmWave link 5C may be, a bidirectional link or unidirectional link, that data is communicated from electronic device 7C to device 8C or vice a versa, at one or more mmWave frequencies. Further, devices 7C, 8C can perform wireless communications with other equipment over a non-mmWave link. Wireless link 3C can be a wireless local area network (WLAN) link i.e. a Wi-Fi link or a wireless personal area network (WPAN) link such as a Bluetooth link.

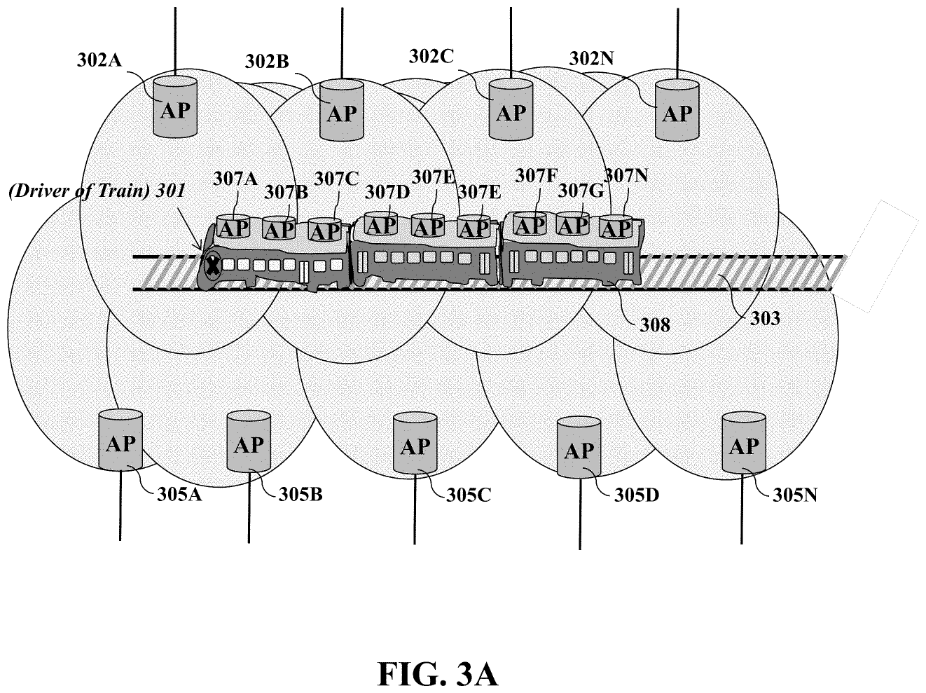

FIG. 2A and FIG. 2B illustrate shows magnitudes 201, 202 of two transmit beams 203, 204, labeled with beam indices 20 and 24 and experimentally measured in an anechoic chamber, according to some embodiments of the present disclosure.

As an overview, the indoor localization method is based on a fully opportunistic use of commercial off-the-shelf (COTS) mmWave WiFi routers. In particular, the proposed method leverages information about mmWave links established between a client and one or more APs that could be extracted from commercial transceiver chipsets. Towards that end, we utilize TP-Link Talon AD7200 router, which is one of the first and most popular WiFi 60 GHz devices complying with the IEEE 802.11ad standard. The TP link router implements Qualcomm QCA9500 transceiver that supports a single stream communication in 60 GHz range using analog beamforming over 32-element planar array. The TP-Link's transceiver receives in quasi-omnidirectional configuration and transmits by steering signal into one of 34 possible beams, realized using pre-stored beamforming weights. Notably, the resulting beams depart from the theoretical ones and exhibit fairly irregular shapes due to hardware imperfections at 60 GHz.

For example, FIG. 2A and FIG. 2B illustrate magnitudes 201, 202 of two transmit beams 203, 204, labeled with beam indices 20 and 24 and experimentally measured in an anechoic chamber. Two TP-Link devices establish mmWave communication link during beam alignment stage whereby one device is in the reception mode, i.e., implements quasi omni-directional beam, and measures the received signal levels of pilots sequentially transmitted over different beams by the other device. Upon this procedure, the two devices swap the roles the repeat the process. The beam alignment procedure yields beam indices to be used during data transmission, along with the RSS level measured over such a link. Following, we extract the recorded RSS and pair of transmit beam indices resulting from the TP-Link's beam alignment procedure and use that information for indoor localization. We emphasize that the developed algorithm can be generalized for the cases when mmWave transceivers employ different beam alignment procedures, for example when quasi-directional receive beams are also employed in addition to transmit beams.

Fingerprinting Stage

FIG. 3A is a schematic illustrating a millimeter wave fingerprinting-based indoor and outdoor localization with beam signal measurements for assisting with railway Applications including communication of railway operation data and railway control communication, according some embodiments of the present disclosure. The Wi-Fi topology of FIG. 3A can be used with the systems and methods of the present disclosure, for improving tracking railway operation data by determining specific times and locations of train/subway car movements, and communicating those times and locations to railway workers and other railway personnel including drivers of the trains.

For example, the Wi-Fi topology of FIG. 3A can include access points (AP) 302A-302N, 305A-305N, deployed on either side of the rail 303. Wherein a set of APs 307A-307N can be positioned on top of each rail car 308, such that AP 307A located in on top of the rail car 308 approximate the driver/conductor's 301 location. Other AP deployments in the train station and trackside areas are contemplated according to conventional AP deployment practices for Wi-Fi topology for rail stations, such that each specific AP deployment can depend on a specific use and country code(s). For example, rail station environments vary widely, from a completely outdoor space to a completely indoor space to a combination of the two, while also having requirements and standards compliances specific to rail deployments. Such that, typically multiple APs can be located on the outside of each rail car 311, including on the top, side, bottom and sides of the rail car, all of which depends on a specific use and the country code(s), according to conventional AP deployment practices for Wi-Fi topology for rail stations.

FIG. 3B is a schematic illustrating another millimeter wave fingerprinting-based indoor and outdoor localization with beam signal measurements for assisting with railway Applications including communication of railway operation data and railway control communication, that further includes cameras/video cameras, according some embodiments of the present disclosure. Wherein, the Wi-Fi topology of FIG. 3B includes cameras/video cameras, that can be used with the systems and methods of the present disclosure, to assist in the tracking of railway operation data by assisting in determining specific times and locations of train car movements.

FIG. 3B shows access points (AP) 312A-312N, 315A-315N, 317A-317N deployed, wherein a set of APs 312A-312N, 317A-317N are positioned on either side of the rails, along with another set of APs 315A-315N located above the rail. The set of APs 315A-315N are located above the rail car 311 and can be attached to supports 314A-314N. Another set of APs 318A-318C are located on top of each rail car 311.

Still referring to FIG. 3B, a set of cameras/video cameras 313A-313N are located on the support 314A-314N and positioned above the rail car 311. The cameras 313A-313N can be conventional IP-enabled video cameras that provide video and audio monitoring of locations and assets along the trackside, according to standard conventional camera deployment practices for camera/video devices for rail stations. Different styles of cameras can be used to view one or more area to be monitored, such as directional cameras for focusing on specific areas, and 360-degree cameras for viewing wide areas, according to standard conventional camera deployment practices for camera/video devices for rail stations. The different cameras and different camera deployment designs depend upon specific uses and country code(s) requirements, according to standard conventional camera deployment practices for camera/video devices for rail stations. The cameras/video cameras 313A-313N can be connected wirelessly to a trackside Ethernet switches (see FIG. 3C 322A-322N and FIG. 3D 332A-332N), for providing both power and connectivity to the cameras/video cameras with a single connection, according to standard conventional camera deployment practices for camera/video devices for rail stations. This can help simplify installation of the cameras/video cameras 313A-313N, and also aid in placing the cameras into position, according to standard conventional camera deployment practices for camera/video devices for rail stations. The video cameras 313A-313N support recording video and audio to different media depending upon the requirements of the rail operator, according to standard conventional camera deployment practices for camera/video devices for rail stations. The fixed position cameras/video cameras 313A-313N are connected to the trackside network (see FIG. 3D, 395), record videos to a centralized server of the centralized wireless access controller server (see FIG. 3C 328 and FIG. 3D 336) in the rail operator's data center part of the CBTC (see FIG. 3C 329 and FIG. 3D 339), according to standard conventional camera deployment practices for camera/video devices for rail stations. The cameras 313A-313N support conventional camera practices of storage to a micro SD card, both as a primary as well as backup storage media, which assures that video and audio can be captured at all times, according to standard conventional camera deployment practices for camera/video devices for rail stations. The video cameras 313A-313N support detection of many different events as triggers, such as loud noises and motion detection, according to standard conventional camera deployment practices for camera/video devices for rail stations. These events can be used to trigger different functions in the video surveillance system, the most common of which is to tag the video for prioritized review at a later date, according to standard conventional camera deployment practices for camera/video devices for rail stations.

The cameras 313A-313N also support an analog input, allowing for contact closures to act as a trigger, according to standard conventional camera deployment practices for camera/video devices for rail stations. Most conventional video practices for rail stations have video for safety and security for rail operation to maintain visual and audio surveillance of the entire operation, including rail stations, trackside infrastructure, and onboard the trains. The conventional IP-enabled video cameras 313A-313N used depends on standardization requirements per specific use or country codes, which include an amount of a specific degree of rugged operation performance, i.e. dust, water, temperature, etc. Since component redundancy is considered as conventional train video system practices, multiple cameras can be at each camera location, according to standard conventional camera deployment practices for camera/video devices for rail stations. Deployment and scaling of video surveillance in fixed locations, such as in the rail station including along the trackside are well documented in existing conventional camera/video deployment design guides.

FIG. 3C and FIG. 3D are schematics illustrating railway communications systems utilizing millimeter wave fingerprinting-based indoor and outdoor localization with beam signal measurements for assisting with railway Applications including communication of railway operation data and railway control communication, according to some embodiments of the present disclosure. The systems and methods of the present disclosure can utilize mobile communication devices 323 and with a central server computer, wherein the communication system or network is established between the central server computer (i.e. a radio-based system described as Communications Based Train Control (CBTC) system 329 of FIG. 3C and 339 of FIG. 3D and the mobile device (i.e. intelligent mobile access point, a smart phone device, etc.) 323 to communicate computer readable information between the central server computer 329 of FIG. 3C and 339 of FIG. 3D and the mobile device 323, i.e. the mobile device can be associated with a user 319 of FIG. 3C.

The CBTC systems 329 of FIG. 3C and 339 of FIG. 3D makes use of the communications between the train 321, 331 and track equipment (395 of FIG. 3D) for traffic management including tracking railway operational data and infrastructure control including determining specific times and locations of train/subway car movements and communicating those times and locations to railway workers and other railway personnel including drivers of the trains/subways.

FIG. 3C shows a configuration of the CBTC 329 in communication with a centralized wireless access controller, i.e. a conventional centralized Wireless Local area network (LAN) Controller (WLC) 328, that is in communication with a hub router 327. The hub router 327 is in communication with a main aggregation router 326 that is in communication with a first sub-aggregation router 324A and a second sub-aggregation routers 324D. The first sub-aggregation router 324A is connected to a first pre-aggregation router 324B, and second sub-aggregation router 324D is connected to a second pre-aggregation router 324C, where first sub-aggregation router 324A can be connected to the sub-aggregation router 324D. The first Pre-aggregation router 324B is connected to Ethernet switches (ESs) 322A to 322N, and the second pre-aggregation router 324C is connected to ESs 322A to 322N, i.e. “N” implies that more ESs are contemplated. Each ES 322A to 322N is in communication with an access point (AP) 325A-325N, i.e. ES 322A is connected with AP 325A; ES 322B is connected with AP 325B; ES 322C is connected with AP 325C; and ES 332N is connected with AP 325N, wherein the APs 325A-325N are positioned within range of the rail 303. Further, the APs 325A-325N are also positioned within range of the APs 328A-328N, which each AP is position on a train car 321.

The APs 328A-328N on the train car 321 and the APs 325A-325N located approximate the trackside can be configured to receive signals from a wireless mobile device 323 associated with a user 319. The wireless mobile device 323 can be a mobile computing apparatus or device, such as personal digital assistants, cellular telephones, smart-phones, and other similar computing devices. The user 319 can be a person associated with some aspect with the rail system. The APs 328A-328N on the train car 321 and the APs 325A-325N located approximate the trackside of the rail 303 can be configured to receive signals from wireless mobile devices, for example if the driver or conductor 301 of the train 331 had a wireless device or other users located within range of the APs 325A-325N, 328A-328N.

FIG. 3D shows another configuration of a CBTC 339 in communication with a centralized wireless access controller, i.e. a conventional centralized Wireless Local area network (LAN) Controller (WLC) 336, in communication with a hub router 337. The hub router 337 is in communication with a main aggregation router 335 that is in communication with a first set of sub-aggregation routers 334A-334D and a second set of sub-aggregation routers 335A-335D. The first set of sub-aggregation routers 334A-334D is connected to a sub-aggregation router 333A, and the second set of sub-aggregation routers 335A-335D is connected to a sub-aggregation router 333D. Sub-aggregation router 333A can be connected to a pre-aggregation router 333B, and sub-aggregation router 333D can be connected to a pre-aggregation router 333C, where sub-aggregation router 333A can be connected to a sub-aggregation router 333D. The pre-aggregation router 333B is connected to Ethernet switches (ES) 332A to 332D, and the pre-aggregation router 333C is connected to ES 332A to 332D. Each ES 332A to 332D is in communication with an access point (AP), i.e. ES 332A is connected with AP 335A; ES 332B is connected with AP 335B; ES 332C is connected with AP 335C; and ES 332D is connected with AP 335N, wherein the APs 335A-335N are positioned within range of the rail 303.

The APs 338A-338N on the train car 331 and the APs 335A-335N located near the trackside of the rail 303 can be configured to receive signals from wireless mobile devices, for example if the driver or conductor 301 of the train 331 had a wireless device or other users having wireless devices.

Still referring to FIG. 3C and FIG. 3D, aspects of the CBTC systems 329, 339 include being able to determine positions of the trains, which this results in a more efficient and safe way to manage the railway traffic. Such that the systems and methods of the present disclosure utilize millimeter wave fingerprinting-based indoor and outdoor localization with beam signal measurements for assisting with railway Applications including communication of railway operation data and railway control communication. Some aspects of the present disclosure are that the CBTC systems 329, 339 can communicate information to the human, for example, the driver or conductor 301, of the train 321, 331 or other users, i.e. railway workers, letting both know of the train 321, 331 exact current location. Thus, railway workers working approximate a moving train 321, 331 approaching the railway workers, the railway workers can be informed to move away from the tracks, in order to ensure the safety of the workers, among other aspects. Further, other data can be provided to the driver of the train or subway and the railway workers including requested railway operation data, weather data, etc., or the data that can be used for and/or relates to operation of the train. In particular, the CBTC system is a bi-directional system that allows for sending (transmitting) an receiving data via hand-held mobile communication devices for communication back and forth to the central server, i.e. CBTC system.

The CBTC systems 329, 339 are a “continuous, automatic train control system utilizing the train location determination, independent from existing track circuits. Essentially, the CBTC system 329, 339 can continuously calculate and communicate each trains status via radio signals. The train status can include train operational data such as position, speed, travel direction and braking distance, which can be used for calculation of an area potentially occupied by each train on the rail 303. For example, the CBTC system 329, 339 can transmit switching lists and other documents used for railway workers, and for drivers of the train for operating the train from either by the driver or by the central server computer to a hand-held mobile device over a network. Other aspects of the CBTC system 329, 339 can be for managing information by compiling a plurality of computer-readable documents used for operating a train to form a train operations kit at a central server computer. Wherein, the computer-readable documents of the train operations kit from the central server computer can be transmitted to a hand-held mobile device over the network. Such that, the hand-held mobile device can display the information of the one or more computer-readable documents on the display of the mobile device. Some unique attributes of the systems and methods of the present disclosure is the capability of using mmWaves for localizing objects such as train cars, drivers of the train cars, and rail workers, in an enclosed indoor area or in an outdoor area. The objects can be associated with a mobile communication device that transmits and/or receives signals to/from some other device(s), or an entity without such a capability. The localizing refers to estimating the coordinates of the object associated with a communication device, in some pre-defined reference frame, such as a train car location, a driver of the train car location and a rail worker. Localization, alternatively, is a proximity detection problem, that aims to localize an object at a sub-area level, within a larger indoor area and an outdoor area. Thus, using mmWaves associated with identifying locations of train cars, drivers of the train cars and rail workers can solve the conventional safety problems associated with rail workers, by accurately determining locations and movements of train cars, as well as distances of the train cars to each rail worker associated with a mobile communication device, among other aspects. Such that the trains can continuously receive information regarding the distance to the preceding train, and are then able to adjust their safety distance accordingly.

Still referring to FIG. 3C and FIG. 3D, some components of the CBTC system 329, 339 include Ethernet switches (ESs) (i.e. FIG. 3C, ES 325A to 325N and FIG. 3D ES 332A to 332D) provide high-speed access for all components and services deployed within the Connected Rail Station. These ES's provide secure connectivity to the deployed devices, power via Power over Ethernet to devices that support it, and service separation, according to standard conventional ES deployment topology. The ESs are configured as an Ethernet ring/network, as part of the trackside network 395 of FIG. 3D. This Ethernet access network implements VLANs to provide secure transport of multiple services over the converged network, wherein the VLANs provide complete separation of services carried over a common Ethernet infrastructure, allowing for the coexistence of multiple services on a single network, which is in accordance with conventional ES deployment topology.

FIG. 3E is a schematic illustrating another conventional high-density Wi-Fi topology for a rail station that can be used with the systems and methods of the present disclosure, according some embodiments of the present disclosure. For example, Ethernet switches (ES) 346A to 346N are in communication to access points (AP) 343A-343N and ES 342A to 342N are in communication to access points (AP) 345A-345N. Also, there are an other set of APs 344A-344N position on top of each train car 341, such that the train cars 341 are positioned on the rail 303 with the driver or conductor 301 in the lead train car.

The Wi-Fi topology of FIG. 3E can be used with the systems and methods of the present disclosure, for improving tracking railway operation data by determining specific times and locations of train/subway car movements, and communicating those times and locations to railway workers and other railway personnel including drivers of the trains. Wherein aspects of the Wi-Fi topology of FIG. 3E illustrates a robust component configuration for furthering enhancement for improving operation of the systems and methods of the present disclosure as well as addressing potential operational demands for specific user needs and country code(s) design constraints. Further, FIG. 3A to FIG. 3E illustrate, among other aspects, different configurations for rail communications where the CBTC equipment can be connected to redundant backbone networks in order to meet specific user interests as well as individual country code(s) design constraints.

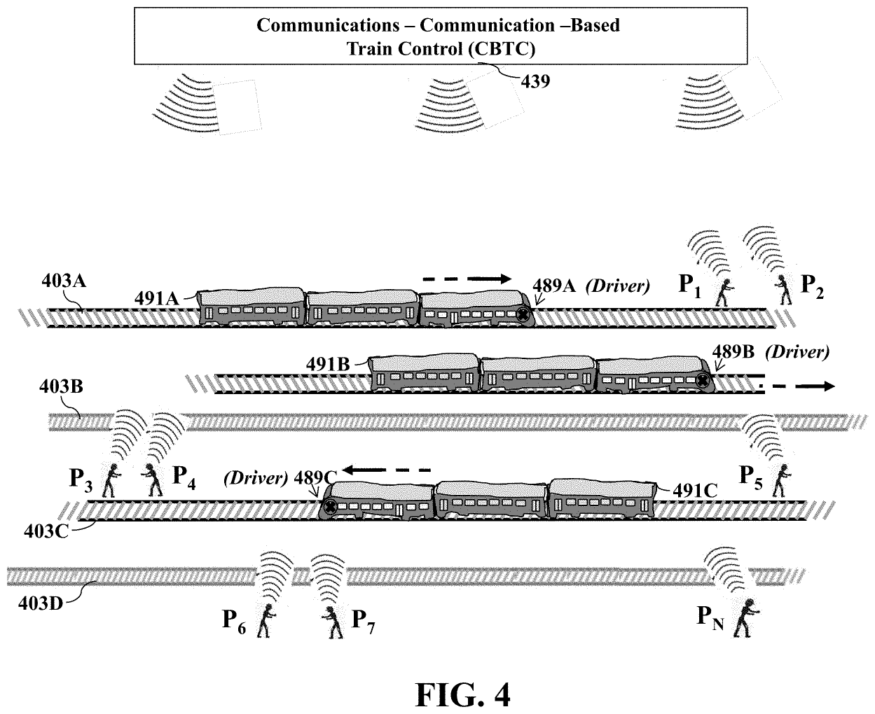

FIG. 4 is a schematic illustrating another millimeter wave fingerprinting-based indoor and outdoor localization with beam signal measurements for assisting with railway Applications including communication of railway operation data and railway control communication, according to some embodiments of the present disclosure. For example, users P1 to PN associated with wireless mobile devices (i.e. indicated as antenna like configurations extending away from the users) are trackside to rails 403A to 403D, wherein the wireless mobile devices are in communication with the CBTC 439. Some of the users can be drivers or conductors 489A to 489C of the trains 491A to 491C, which may also have an associated wireless mobile device (not shown).

Still referring to FIG. 4, mmWaves can be used for localizing objects such as train cars 491A to 491C, users P1 to PN associated with wireless mobile devices, and drivers or conductor 489A to 489C of the trains 491A to 491C, can be in an enclosed indoor area or in an outdoor area associated with a rail station. Wherein the wireless mobile devices are localized, i.e. estimated coordinates associated with wireless mobile devices, which is used to solve and overcome the conventional safety problems associated with railroad workers, by accurately determining locations and movements of them, as well as distances of them to each train car. For example, the “states of environments” can include locations of physical objects, i.e. wireless mobile device associated with user and trains, and types of behavior of ambient users in the train station environment. Also, the “states of the devices” can include types of behavior associated with each wireless mobile device (wherein a user can be associated with each device), locations and poses of each device in each environment, as well as train location, direction, etc.

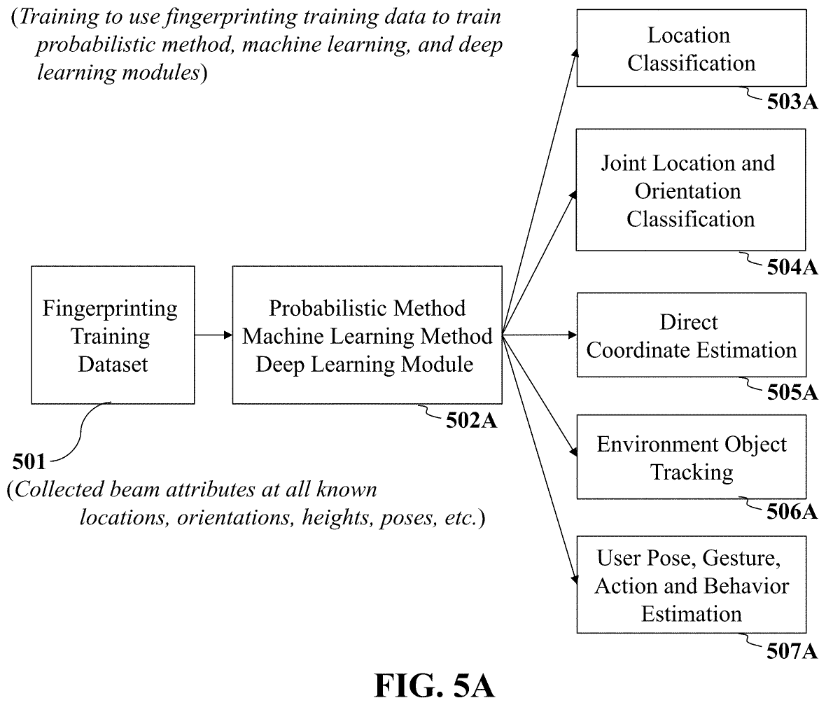

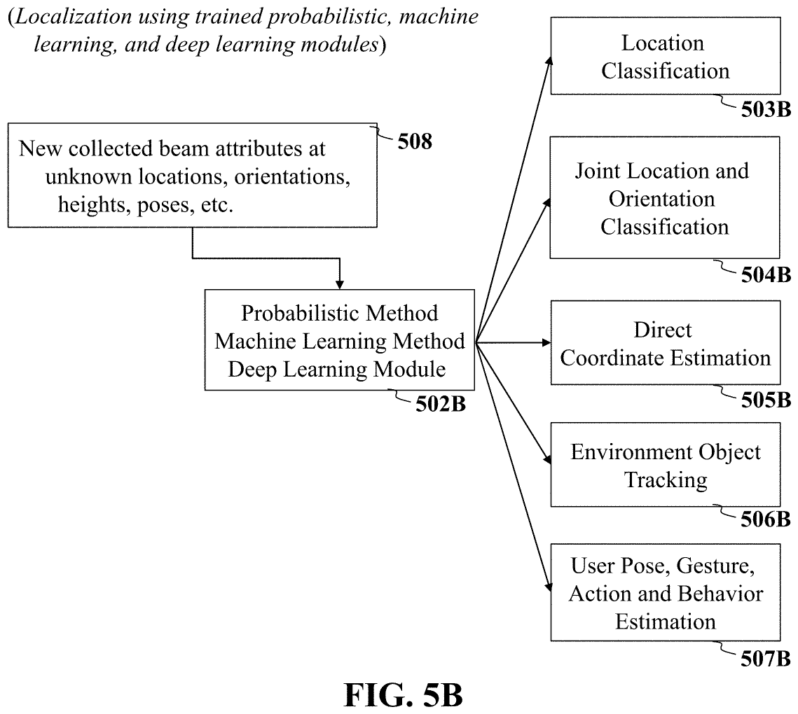

FIG. 5A is a block diagram of using the fingerprinting training dataset 501 to train various modules 502A such as probabilistic method, machine learning and deep learning modules for various purposes 503A, 504A, 505A, 506A, 507A which can be used for the keyless entrance application.

FIG. 5B is a block diagram of applying trained various modules 502B to the new beam attributes 508 to estimate location, orientation, heights, poses, etc. 503B, 504B, 505B, 506B, 507B which can be used for the keyless entrance application.

Probabilistic Method

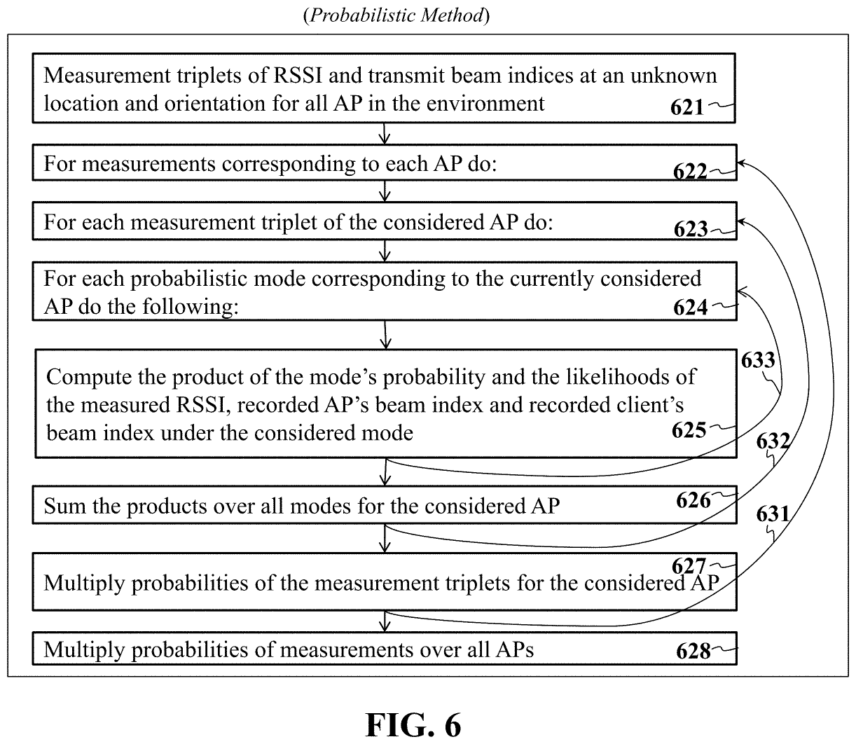

FIG. 6 is a block diagram of illustrating a probabilistic method computing the likelihood of all measurements at a location-orientation pair (l, o), according to some embodiments of the present disclosure. The input 621 consists of I measurement triplets for each of K access points. The measurement triplet in this embodiment consists of the measured RSSI value and two beam indices, however, as previously elaborated, there could be more beam indices contained in one measurement instance. Given the input and hypothesized location, orientation pair, loops through measurements of all AP's 622 and then loops through the measured triplets of each considered AP 623. Then, to compute the likelihood of the considered measurement triplet, the method loops through all modes corresponding to the considered AP 624 and computes the likelihood of the measurement triplet under each mode. That is done by computing the product 625 of the mode probability, likelihood of the RSSI, likelihood of the recorded AP's beam index and likelihood of the AP's beam index, where the RSSI and beam indices are from the considered measured triplet. This product is essentially the term under the summation in (14). The mode probability is contained in the stored summary of the fingerprint measurements, the RSSI likelihood is obtained or the combination of (5) and (6), while the likelihood of beam index is computed either using (15) or (16). The likelihoods of the considered measurement triplets under all different modes are computed by looping 633 through all of modes corresponding to the considered AP and are then summed 626 to yield the likelihood of the considered measurement triplet. The method loops 632 through all measurement triplets corresponding to the considered AP, computes their probabilities and multiplies those together 627. Finally, the method loops 631 through all AP's, computes probability of the measurements corresponding to each AP present in the environment and multiplies them 628 to yield the final probability of all measurements at some location-orientation pair. We note that the sum in (14) loops through the modes 633, while the products in (13) loop through APs 631 and measurement triplets 632, respectively.

This likelihood of all measurements for some location-orientation pair is substituted into (12), together with possibly non-uniform prior p(l, o), to eventually yield (after normalization) the posterior distribution of location-orientation pairs. The client's location and orientation are detected based on its measurements M as the location-orientation pair with the largest posterior probability,

$$\hat{l} , \hat{o} = {arg max}_{l , o} p ( l , o \vert ℳ , 𝒮 ) , \qquad ( Eq . 17 )$$

Machine Learning Module

For the machine learning and deep learning models, we use the beam SNR as the link attributes. For practical 60-GHz WI-FI devices such as commercial access points (APs), a fixed set of varying beam sectors are swept in a pre-defined time order. For instance, the first 60 GHz device that fully implements the IEEE 802.11ad standard, TP-Link Talon AD7200 router with a phased array of 32 antenna elements has 36 pre-defined beam sectors. Due to the antenna housing and calibration, irregular antenna beam patterns are used in the phase array. Two of such irregular antenna beam patterns are shown in FIGS. 2A and 2B. Given the antenna beam patterns, the beam SNR for the m-th beam pattern is defined as

$${h}_{m} = Beam {SNR}_{m} = \frac{{\sum }_{i = 1}^{I} {γ}_{m} ( {θ}_{i} ) P ( {θ}_{i} )}{{σ}^{2}} , \qquad ( Eq . 1 )$$

where I is the total number of (LoS/NLoS) paths, θᵢ is the azimuth angle for the i-th path, P(θᵢ) is the signal power at the i-th path, γₘ(θᵢ) is the m-th antenna beam pattern gain at the i-th path, and σ² is the noise variance.

To construct the fingerprinting dataset, we stack all SNR measurements from all beam sectors as a vector, e.g., h=[h₁, h₂, . . . , h_{M}]^{T}. When multiple APs are used, we combine beam SNR measurements from each AP to form one fingerprinting snapshot, i.e., \tilde{h}=[h₁^{T}, h₂^{T}, . . . , h_{P}^{T}]ϵ [symbol] ^{MP×1}, where P is the number of APs. For a given location and orientation, R fingerprinting snapshots, \tilde{h}₁(l, o), . . . , \tilde{h}_{R}(l, o), are collected to construct the offline training dataset, where l and o are the indices for the location and orientation, respectively.

By collecting many realizations of beam SNR measurements at multiple APs over L locations-of-interests and O orientations, we will have LO sets of MP×R beam SNR measurements in the training dataset.

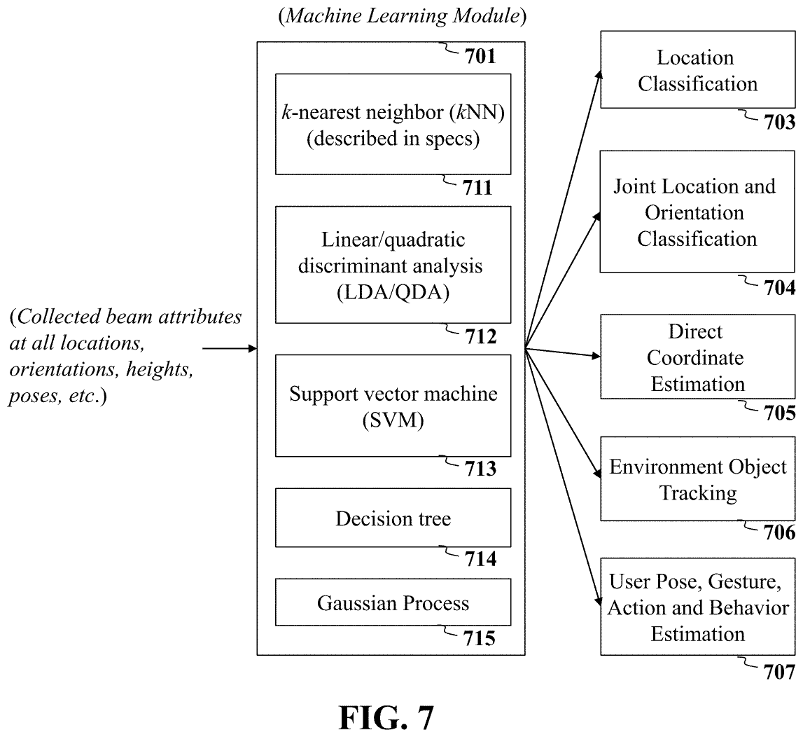

FIG. 7 is a block diagram illustrating that when new fingerprinting measurements from an unknown location are available, the problem of interest is to, with a chosen performance metric, find a best match of the new measurements in the offline training dataset and determine its location and/or orientation, using machine learning methods, including linear/quadratic discriminant analysis (LDA/QDA), support vector machine (SVM), decision tree (DT)), the nearest neighboring-based method, Gaussian process, for classification and coordinate estimation. While some embodiments estimate states of radio devices such as locations and orientations, other embodiments are based on a recognition that mmWave beam signal can be sensitive to states of environment such as physical object locations, door openings, ambient users actions and occupancies such that the present disclosure can estimate those states of environment in a same manner of estimating states of the devices.

Still referring to FIG. 7, then only the location is of interest, we can simply repeat the above process by only using the location label from the training dataset. Similarly, one can apply other classification methods to the beam SNR measurements.

Deep Learning

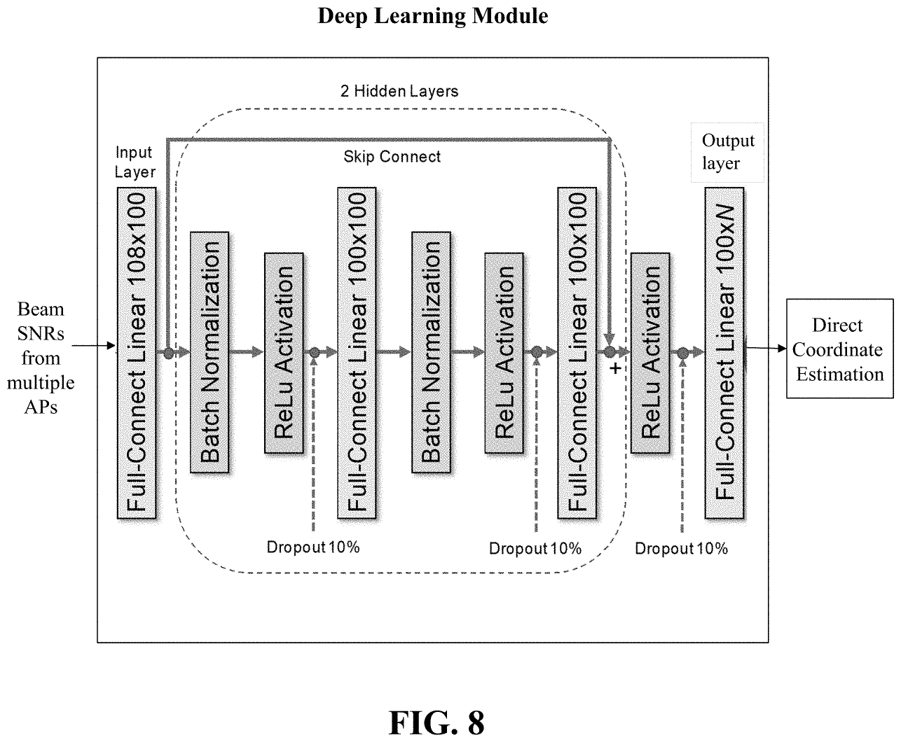

FIG. 8 is a schematic illustrating a DNN architecture for localizations, according to some embodiments of the present disclosure. The DNN feeds beam SNRs information measured at the beam-training phase of COTS IEEE 802.11ad devices, which searches for the best beam pattern by sweeping multiple predefined beam profiles. When multiple APs exist nearby, makes possible to exploit beam SNRs from all APs to improve the localization accuracy.

When 36 beam sectors are available from three APs, 108 SNR information is fed into the input layer of the DNN, where the input layer first transforms to 100-node dimensions by fully connected linear layer. The DNN then employs two hidden layers having 100 nodes per layer, consisting of batch normalization layer, rectified linear unit (ReLU) activation layer with 10% dropout, and fully connected linear layer. The dropout is a technique to prevent over-fitting for improved generalizability. Additionally, considered is a skip connect jumping from the input of hidden layers to the output of hidden layers in order to learn residual gradient for improved training stability. A fully connected linear layer following an activation layer with dropout produces the output of the DNN.

Still referring to FIG. 8, the dimensionality of the output layer depends on the localization scenarios. Specifically, three localization scenarios are investigated; i) location identification, ii) joint location & orientation identification, and iii) location coordinate estimation. For the first two scenarios, the DNN is trained to minimize softmax cross-entropy loss to predict identification from multiple pre-defined location landmarks. For location identification, the dimension of output nodes is L while it is L×O for joint location and orientation identification. Whereas for the last scenario, the DNN produces estimated (x, y) coordinate value by training in the sense of mean-square error (MSE) loss. For this case, the number of output nodes is just two, representing (x, y).

For example, a Chainer library is used for the DNN implementation. DNN training was performed by adaptive momentum (Adam) stochastic gradient descent method with a learning rate of 0.001, and a mini-batch size of 100. The maximum number of epochs is 500 while early stopping with a patience of 20 was taken place.

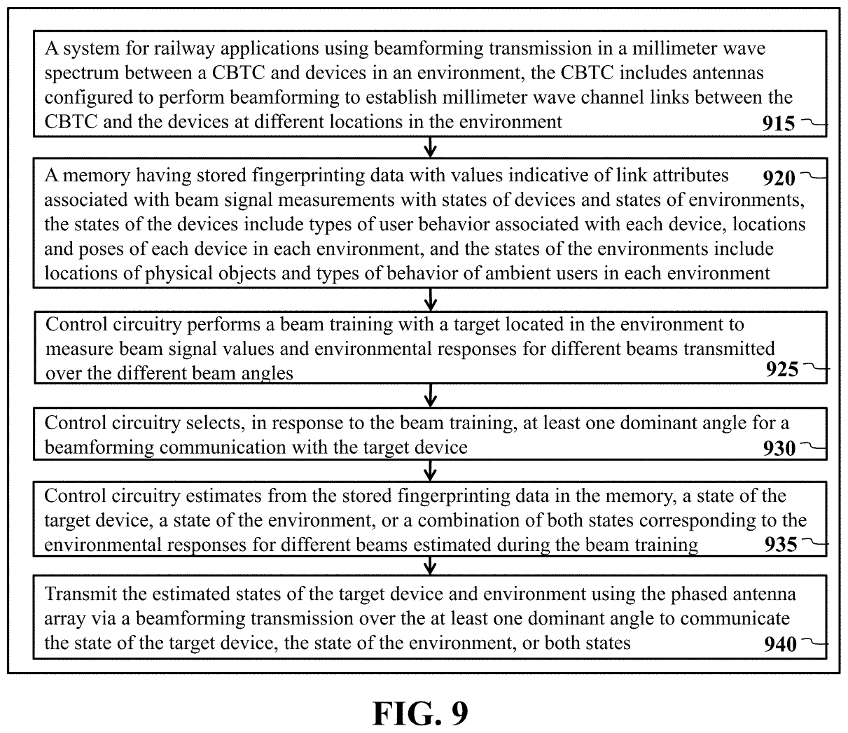

FIG. 9 is a block diagram of a method, according to an embodiment of the present disclosure.

Step 915 of FIG. 9 includes a communication system using beamforming transmission in a millimeter wave spectrum in an environment that includes antennas configured to perform beamforming to establish millimeter wave channel links with devices at different locations in the environment.

Step 920 of FIG. 9 includes a memory connected to the antennas, having stored fingerprinting data. The stored fingerprinting data include values indicative of link attributes associated with beam signal measurements with states of devices and states of environments. The states of the devices include types of user behavior associated with each device, locations and poses of each device in each environment. The states of the environments include locations of physical objects and types of behavior of ambient users in each environment.

Step 925 of FIG. 9 includes the control circuitry communicatively connected with the antennas and the memory, is configured to perform a beam training with a target device located in the environment to measure beam signal values and environmental responses for different beams transmitted over the different beam angles.

Step 930 of FIG. 9 includes the control circuitry selects, in response to the beam training, at least one dominant angle for a beamforming communication with the target device.

Step 935 of FIG. 9 includes the control circuitry estimates from the stored fingerprinting data in the memory, a state of the target device, a state of the environment, or a combination of both states corresponding to the environmental responses for different beams estimated during the beam training

Step 940 of FIG. 9 includes the control circuitry transmits the estimated states of the target device and environment using the antennas via a beamforming transmission over the at least one dominant angle to communicate the state of the target device, the state of the environment, or both states.

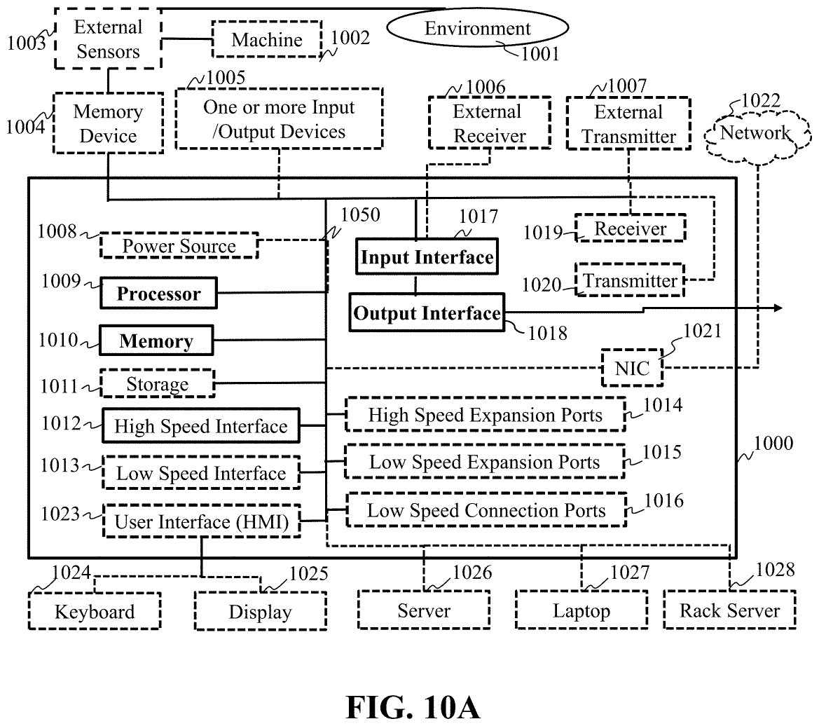

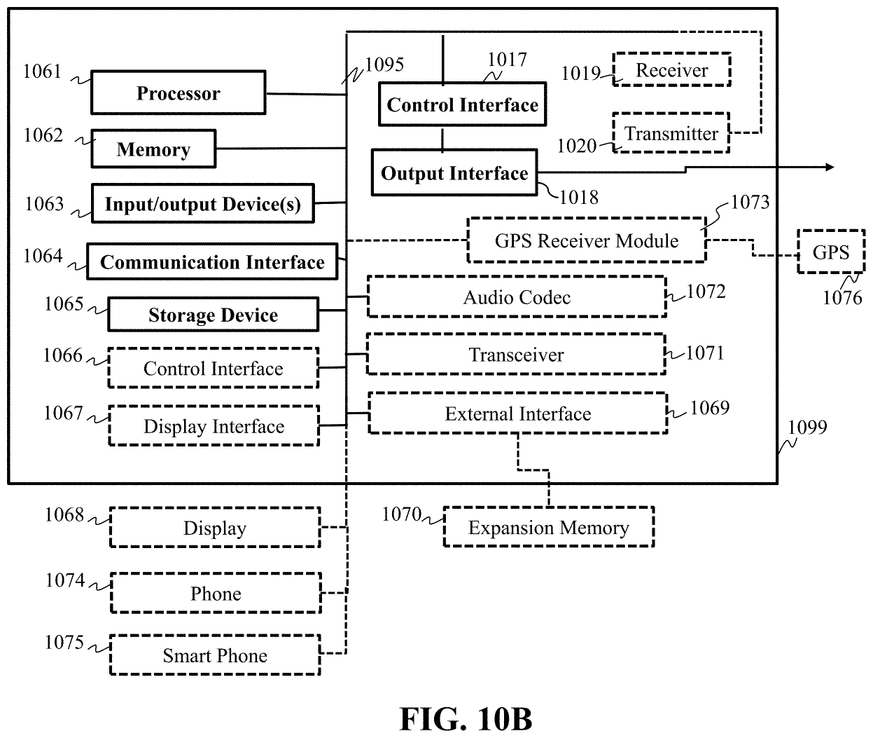

FIG. 10A is a schematic illustrating by non-limiting example a computing apparatus 1000 that can be used to implement some techniques of the methods and systems, according to embodiments of the present disclosure. The computing apparatus or device 1000 represents various forms of digital computers, such as laptops, desktops, workstations, personal digital assistants, servers, blade servers, mainframes, and other appropriate computers.

The computing device 1000 can include a power source 1008, a processor 1009, a memory 1010, a storage device 1011, all connected to a bus 1050.

The power source 1008 can be one or more types of power, including battery, solar, wind, on-board power generator device, power generated from a device, i.e. car, train, etc. For example, there can be a power converter or power system that can converter generated power, i.e. solar, wind, self-generating power source via gasoline, gas, and the like, that may have a different voltage, current or phase that may need to be converted, i.e. 6V DC, 12V DC, etc., to a useable energy source, i.e. 120 A/C, whatever the power conversion maybe, for power to be provided for the intended purpose as related to embodiments of the present disclosure.

Further, a high-speed interface 1012, a low-speed interface 1013, high-speed expansion ports 1014 and low speed connection ports 1015, can be connected to the bus 1050. In addition, a low-speed expansion port 1016 is in connection with the bus 1050. Contemplated are various component configurations that may be mounted on a common motherboard, by non-limiting example, 1030, depending upon the specific application. Further still, an input interface 1017 can be connected via bus 1050 to an external receiver 1006 and an output interface 1018. A receiver 1019 can be connected to an external transmitter 1007 and a transmitter 1020 via the bus 1050. Also connected to the bus 1050 can be an external memory 1004, external sensors 1003, machine(s) 1002 and an environment 1001. Further, one or more external input/output devices 1205 can be connected to the bus 1050. A network interface controller (NIC) 1021 can be adapted to connect through the bus 1050 to a network 1022, wherein data or other data, among other things, can be rendered on a third party display device, third party imaging device, and/or third party printing device outside of the computer device 1000.

Contemplated is that the memory 1010 can store instructions that are executable by the computer device 1000, historical data, and any data that can be utilized by the methods and systems of the present disclosure. The memory 1010 can include random access memory (RAM), read only memory (ROM), flash memory, or any other suitable memory systems. The memory 1010 can be a volatile memory unit or units, and/or a non-volatile memory unit or units. The memory 1010 may also be another form of computer-readable medium, such as a magnetic or optical disk.

Still referring to FIG. 10A, a storage device 1011 can be adapted to store supplementary data and/or software modules used by the computer device 1000. For example, the storage device 1011 can store historical data and other related data as mentioned above regarding the present disclosure. Additionally, or alternatively, the storage device 1011 can store historical data similar to data as mentioned above regarding the present disclosure. The storage device 1011 can include a hard drive, an optical drive, a thumb-drive, an array of drives, or any combinations thereof. Further, the storage device 1011 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 1009), perform one or more methods, such as those described above.

The system can be linked through the bus 1050 optionally to a display interface or user Interface (HMI) 1023 adapted to connect the system to a display device 1025 and keyboard 1024, wherein the display device 1025 can include a computer monitor, camera, television, projector, or mobile device, among others.

Still referring to FIG. 10A, the computer device 1000 can include a user input interface 1017 adapted to a printer interface (not shown) can also be connected through bus 1050 and adapted to connect to a printing device (not shown), wherein the printing device can include a liquid inkjet printer, solid ink printer, large-scale commercial printer, thermal printer, UV printer, or dye-sublimation printer, among others.

The high-speed interface 1012 manages bandwidth-intensive operations for the computing device 1000, while the low-speed interface 1013 manages lower bandwidth-intensive operations. Such allocation of functions is an example only. In some implementations, the high-speed interface 1012 can be coupled to the memory 1010, a user interface (HMI) 1023, and to a keyboard 1024 and display 1025 (e.g., through a graphics processor or accelerator), and to the high-speed expansion ports 1014, which may accept various expansion cards (not shown) via bus 1050. In the implementation, the low-speed interface 1013 is coupled to the storage device 1011 and the low-speed expansion port 1015, via bus 1050. The low-speed expansion port 1015, which may include various communication ports (e.g., USB, Bluetooth, Ethernet, wireless Ethernet) may be coupled to one or more input/output devices 1005, and other devices a keyboard 1024, a pointing device (not shown), a scanner (not shown), or a networking device such as a switch or router, e.g., through a network adapter.

Still referring to FIG. 10A, the computing device 1200 may be implemented in a number of different forms, as shown in the figure. For example, it may be implemented as a standard server 1026, or multiple times in a group of such servers. In addition, it may be implemented in a personal computer such as a laptop computer 1027. It may also be implemented as part of a rack server system 1028. Alternatively, components from the computing device 1000 may be combined with other components in a mobile device (not shown), such as a mobile computing device of FIG. 10B. Each of such devices may contain one or more of the computing device and the mobile computing device, and an entire system may be made up of multiple computing devices communicating with each other.

FIG. 10B is a schematic illustrating a mobile computing apparatus that can be used to implement some techniques of the methods and systems, according to embodiments of the present disclosure. The mobile computing device 1099 includes a bus 1095 connecting a processor 1061, a memory 1062, an input/output device 1063, and a communication interface 1064, among other components. The bus 1095 can also be connected to a storage device 1265, such as a micro-drive or other device, to provide additional storage.

Referring to FIG. 10B, the processor 1061 can execute instructions within the mobile computing device, including instructions stored in the memory 1062. The processor 1061 may be implemented as a chipset of chips that include separate and multiple analog and digital processors. The processor 1061 may provide, for example, for coordination of the other components of the mobile computing device, such as control of user interfaces, applications run by the mobile computing device, and wireless communication by the mobile computing device 1000B. Contemplated are various component configurations that may be mounted on a common motherboard, by non-limiting example, 1099, depending upon the specific application.

The processor 1061 may communicate with a user through a control interface 1066 and a display interface 1067 coupled to the display 1068. The display 1068 may be, for example, a TFT (Thin-Film-Transistor Liquid Crystal Display) display or an OLED (Organic Light Emitting Diode) display, or other appropriate display technology. The display interface 1067 may comprise appropriate circuitry for driving the display 1068 to present graphical and other information to a user. The control interface 1066 may receive commands from a user and convert them for submission to the processor 1061. In addition, an external interface 1069 may provide communication with the processor 1061, to enable near area communication of the mobile computing device with other devices. The external interface 1069 may provide, for example, for wired communication in some implementations, or for wireless communication in other implementations, and multiple interfaces may be used.

Still referring to FIG. 10B, the memory 1062 stores information within the mobile computing device. The memory 1062 can be implemented as one or more of a computer-readable medium or media, a volatile memory unit or units, or a non-volatile memory unit or units. An expansion memory 1070 may also be provided and connected to the mobile computing device 1099 through an expansion interface 1069, which may include, for example, a SIMM (single in line memory module) card interface. The expansion memory 1070 may provide extra storage space for the mobile computing device 1099, or may also store applications or other information for the mobile computing device 1099. Specifically, the expansion memory 1070 may include instructions to carry out or supplement the processes described above, and may include secure information also. Thus, for example, the expansion memory 1070 may be providing as a security module for the mobile computing device 1099, and may be programmed with instructions that permit secure use of the mobile computing device. In addition, secure applications may be provided via the SIMM cards, along with additional information, such as placing identifying information on the SIMM card in a non-hackable manner.

The memory 1062 may include, for example, flash memory and/or NVRAM memory (non-volatile random access memory), as discussed below. In some implementations, instructions are stored in an information carrier, that the instructions, when executed by one or more processing devices (for example, processor), perform one or more methods, such as those described above. The instructions can also be stored by one or more storage devices, such as one or more computer or machine-readable mediums (for example, the memory 1062, the expansion memory 1070, or memory on the processor 1062). In some implementations, the instructions can be received in a propagated signal, for example, over the transceiver 1071 or the external interface 1069.

The mobile computing apparatus or device of FIG. 10B is intended to represent various forms of mobile devices, such as personal digital assistants, cellular telephones, smart-phones, and other similar computing devices. The mobile computing device may communicate wirelessly through the communication interface 1064, which may include digital signal processing circuitry where necessary. The communication interface 1064 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1071 using a radio frequency. In addition, short-range communication may occur, such as using a Bluetooth, Wi-Fi, or other such transceiver (not shown). In addition, a GPS (Global Positioning System) receiver module 1073 may provide additional navigation and location related wireless data to the mobile computing device, which may be used as appropriate by applications running on the mobile computing device.

The mobile computing device may also communicate audibly using an audio codec 1072, which may receive spoken information from a user and convert it to usable digital information. The audio codec 1072 may likewise generate audible sound for a user, such as through a speaker, e.g., in a handset of the mobile computing device. Such sound may include sound from voice telephone calls, may include recorded sound (e.g., voice messages, music files, etc.) and may include sound generated by applications operating on the mobile computing device.

Still referring to FIG. 10B, the mobile computing device may be implemented in a number of different forms, as shown in the figure. For example, it may be implemented as a cellular telephone 1074. It may also be implemented as part of a smart-phone 1075, personal digital assistant, or other similar mobile device.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A communication system for railway applications using beamforming transmission in a millimeter wave spectrum between a central server computer or a radio-based system such as a Communications Based Train Control (CBTC) system and devices in an environment to establish the communication system, the CBTC system includes phased antenna arrays configured to perform beamforming to establish millimeter wave channel links between the CBTC system and the devices at different locations in the environment, the devices include a target device and the environment includes a train station area, the communication system comprising:
memory connected to phased antenna arrays and stored data, the stored data include values indicative of signal to noise ratio (SNR) measurements of a set of beams emitted at different beam angles by the access point phased antenna arrays and measured at a set of locations, that provide for a mapping between different combinations of SNR values of the set of beams and the set of locations, such that a location from the set of locations is mapped to a unique combination of the SNR values of the set of beams;
control circuitry communicatively connected with the phased antenna arrays and the memory, configured to:
perform a beam training with the target device located in the environment to estimate SNR values for different beams transmitted over the different beam angles;
select, in response to the beam training, at least one dominant angle for a beamforming communication with the target device;
estimate from the mapping stored in the memory, a location of the target device corresponding to the SNR values for different beams estimated during the beam training; and
transmit the estimated location of the target device using the phased antenna arrays via a beamforming transmission over the at least one dominant angle.

2. The communication system of claim 1, wherein each phased antenna array includes antenna beam sectors, such that the phased antenna array iteratively sweeps the environment, sequentially, to establish at least one millimeter wave link with the devices and the target device in the environment.

3. The communication system of claim 1, wherein the stored data include each location from the set of locations that is mapped to the unique combination of the SNR values of the set of beams for a period of time, such that the unique combination of the SNR values of the set of beams at that period of time further provides information associated with types of behavior of the device at the location for that period of time, poses of the device at the location for that period of time, locations of physical objects in the environment for that period of time, and types of behavior of ambient users in the environment for that period of time.

4. The communication system of claim 1, wherein stored data include values indicative of link attributes including one of beam received signal strength indicator (RSSI) measurements, beam channel state information (CSI) measurements, beam patterns or beam sequencing, wherein each link attribute includes measurements of a set of beams emitted at different beam angles by the phased array of antennas and measured at a set of locations in the environment, wherein the stored values provide a mapping between different combinations of at least one link attribute values of the set of beams and the set of locations, such that a location from the set of locations is mapped to a unique combination of the at least one link attribute values of the set of beams.

5. The communication system of claim 4, wherein the link attributes further includes one or a combination of RSSI measurements or CSI measurements.

6. The communication system of claim 1, wherein the control circuitry is configured to control a mechanical positioner to mechanically adjust an orientation of the phased antenna array and/or control a beam steering circuitry to steer the millimeter wave signals towards the location of the target device.

7. The communication system of claim 1, wherein each device of the devices includes a phased antenna array having antenna beam sectors that sweep the environment, such that some devices of the devices are commercial off-the-shelf (COTS) devices.

8. The communication system of claim 1, wherein the target device is associated with an electronic device capable of establishing a link with the phased array of antennas, such that the target device is further associated with one of a robot, a human, a computer, a computer like device or an electronic device adaptable to a human.

9. A electronic communication system for railway applications using beamforming transmission in a millimeter wave spectrum between a central server computer or a radio-based system such as a Communications Based Train Control (CBTC) system and devices in an environment to establish the communication system, the CBTC system includes antennas configured to transmit and receive millimeter wave signals between the CBTC system and the devices at different locations in the environment, wherein the devices includes a target device and the environment includes a train station area, comprising:
a memory connected to the antennas and stored data, the stored data include values indicative of signal to noise ratio (SNR) measurements of a set of beams emitted at different beam angles by the antennas and measured at a set of locations, that provide for a mapping between different combinations of SNR values of the set of beams and the set of locations, such that a location from the set of locations is mapped to a unique combination of the SNR values of the set of beams;
control circuitry connected with the antennas and the memory, is configured to:
perform a beam training with the target device located in the environment to estimate SNR values for different beams transmitted over the different beam angles;
select, in response to the beam training, at least one dominant angle for a beamforming communication with the target device;
estimate from the mapping stored in the memory, a location of the target device corresponding to the SNR values for different beams estimated during the beam training; and
transmit the estimated location of the target device using the antennas via a beamforming transmission over the at least one dominant angle.

10. The electronic system of claim 9, wherein the antennas are associated with access points such that each antenna is arranged in a phased antenna array, and configured to transmit and receive millimeter wave signals between the antennas of the CBTC system and the devices at different locations in the environment.

11. The electronic system of claim 10, further comprising a mechanical positioner coupled to each phased antenna array, the control circuitry configured to mechanically adjust a position of at least one antenna in the phased antenna array to direct the millimeter wave signals towards a location of the target device by controlling the mechanical positioner.

12. The electronic system of claim 11, further comprising beam steering circuitry coupled to each phased antenna array, the control circuitry configured to
steer the millimeter wave signals towards the location of the target device by controlling the beam steering circuitry, and steer the millimeter wave signals towards the location of the target device after the mechanical positioner mechanically adjusts the position of the at least one antenna in the phased antenna array.

13. A method using a communication system for railway applications utilizing beamforming transmission in a millimeter wave spectrum between a central server computer or a radio-based system such as a Communications Based Train Control (CBTC) system and devices in an environment to establish the communication system, the CBTC system includes phased antenna arrays configured to perform beamforming to establish millimeter wave channel links between the CBTC system and the devices at different locations in the environment, wherein the devices include a target device and the environment includes a train station area, comprising:
performing a beam training with the target device located in the environment to estimate signal to noise ratio (SNR) measurement values for different beams transmitted over the different beam angles using control circuitry connected with the phased antenna arrays, the control circuitry is configured for:
selecting, in response to the beam training, at least one dominant angle for a beamforming communication with the target device;
accessing a memory connected to the phased antenna arrays, the memory having stored data that include values indicative of SNR measurements of a set of beams emitted at different beam angles by the phased antenna array and measured at a set of locations in the environment, wherein the stored values provide a mapping between different combinations of SNR values of the set of beams and the set of locations, such that a location from the set of locations is mapped to a unique combination of the SNR values of the set of beams;
estimating from the mapping stored in the memory, a location of the target device corresponding to the SNR values for different beams estimated during the beam training; and
transmitting the estimated location of the target device using the phased antenna arrays via a beamforming transmission over the at least one dominant angle.

14. The method of claim 13, wherein the stored data includes fingerprinting data, the fingerprinting data include each location from the set of locations mapped to the unique combination of the SNR values of the set of beams for a period of time, such that the unique combination of the SNR values of the set of beams at that period of time further provides information associated with types of behavior of the device at the location for that period of time, poses of the device at the location for that period of time, locations of physical objects in the environment for that period of time, and types of behavior of ambient users in the environment for that period of time.

15. The method of claim 13, wherein the target device is associated with an electronic device capable of establishing a link with the phased array of antennas, such that the target device is further associated with one of a robot, a human, a computer, a computer like device or an electronic device adaptable to a human.

16. A communication system for railway applications using beamforming transmission in a millimeter wave spectrum between a central server computer or a radio-based system such as a Communications Based Train Control (CBTC) system and devices in an environment, the CBTC system hat includes antennas configured to perform beamforming to establish millimeter wave channel links between the CBTC system and the devices at different locations in the environment, wherein the devices include a target device and the environment includes a train station area, comprising:
a memory connected to the antennas includes stored fingerprinting data, the stored fingerprinting data include values indicative of link attributes associated with beam signal measurements with states of devices and states of environments, the states of the devices include types of user behavior associated with each device, locations and poses of each device in each environment, and the states of the environments include locations of physical objects and types of behavior of ambient users in each environment;
control circuitry communicatively connected with the phased antenna arrays and the memory, is configured to:
perform a beam training with the target device located in the environment to measure beam signal values and environmental responses for different beams transmitted over the different beam angles;
select, in response to the beam training, at least one dominant angle for a beamforming communication with the target device;
estimate from the stored fingerprinting data in the memory, a state of the target device, a state of the environment, or a combination of both states corresponding to the environmental responses for different beams estimated during the beam training; and
transmit the estimated states of the target device and environment using the antennas via a beamforming transmission over the dominant angle to communicate the state of the target device, the state of the environment, or both states.

17. The communication system of claim 16, wherein the link attributes includes one or a combination of, beam signal to noise ratio (SNR) measurements, beam received signal strength indicator measurements, beam channel state information (CSI) measurements, beam patterns or beam sequencing, and wherein each device is associated with a user, such that the user is one of a robot, a human, a computer, a computer like device or an electronic device adaptable to a human.

18. A method using a communication system for railway applications having beamforming transmission in a millimeter wave spectrum between a central server computer or a radio-based system such as a Communications Based Train Control (CBTC system and devices in an environment, the CBTC system that includes antennas configured to perform beamforming to establish millimeter wave channel links between the CBTC system and the devices at different locations in the environment, wherein the devices include a target device and the environment includes a train station area, comprising:
performing a beam training with the target device located in the environment to measure beam signal values and environmental responses for different beams transmitted over the different beam angles using control circuitry connected with the antennas, the control circuitry is configured for:
selecting, in response to the beam training, at least one dominant angle for a beamforming communication with the target device;
accessing a memory connected to the antennas, the memory having stored fingerprinting data that include values indicative of link attributes associated with beam signal measurements with states of devices and states of environments, the states of the devices include types of user behavior associated with each device, locations and poses of each device in each environment, and wherein the states of the environments include locations of physical objects and types of behavior of ambient users in each environment;
estimating from the mapping stored fingerprinting data in the memory, a state of the target device, a state of the environment, or a combination of both states corresponding to the environmental responses for different beams estimated during the beam training; and
transmitting the estimated states of the target device and environment using the antennas via a beamforming transmission over the at least one dominant angle to communicate the state of the target device, the state of the environment, or both states.

19. The method of claim 18, wherein the link attributes includes one or a combination of, beam signal to noise ratio (SNR) measurements, beam received signal strength indicator measurements, beam CSI measurements, beam patterns or beam sequencing, and wherein each device is associated with a user, such that the user is one of a robot, a human, a computer, a computer like device or an electronic device adaptable to a human.

20. The method of claim 18, wherein the antennas are associated with access points, such that each antenna is arranged in a phased antenna array, and configured to transmit and receive millimeter wave signals with the devices at different locations in the environment.
